(19) United States
(12) Patent Application Publication
(10) Pub. No.: US 2025/0227617 A1
(43) Pub. Date: Jul. 10, 2025

(54) METHOD AND APPARATUS FOR SAVING ENERGY IN WIRELESS COMMUNICATION SYSTEM

(71) Applicant: Samsung Electronics Co., Ltd., Suwon-si (KR)

(72) Inventors: Junyung YI, Suwon-si (KR); Youngbum KIM, Suwon-si (KR); Younsun KIM, Suwon-si (KR); Hyunsuk RYU, Suwon-si (KR)

(21) Appl. No.: 19/014,923

(22) Filed: Jan. 9, 2025

(30) Foreign Application Priority Data
Jan. 10, 2024 (KR) 10-2024-0004354

(51) Int. Cl. H04W 52/02; H04W 74/0833

(52) U.S. Cl. CPC H04W 52/0235; H04W 74/0833; H04W 74/0866

(57) ABSTRACT

A method performed by a user equipment (UE) in a wireless communication system is provided. The method includes receiving, on a cell of a base station, configuration information regarding an uplink (UL) wake up signal (WUS) for at least one cell, transmitting, via physical random access channel (PRACH), the UL WUS based on the configuration information, and receiving an on-demand system information block (SIB) on the at least one cell, based on the UL WUS.

### CROSS-REFERENCE TO RELATED APPLICATION(S)

This application is based on and claims priority under 35 U.S.C. § 119 (a) of a Korean patent application number 10-2024-0004354, filed on Jan. 10, 2024, in the Korean Intellectual Property Office, the disclosure of which is incorporated by reference herein in its entirety.

### BACKGROUND

### 1. Field

The disclosure relates to operations of a user equipment and a base station in a wireless communication system. More particularly, the disclosure relates to a method and apparatus for saving energy in a wireless communication system.

### 2. Description of Related Art

A 5^{th} generation (5G) mobile communication technology defines a broad frequency band to enable a high data rate and new services, and may be implemented not only in a ‘Sub 6 GHz’ band such as 3.5 GHz but also in an ultra high frequency band (‘Above 6 GHz’) referred to as millimeter wave (mmWave) such as 28 GHZ, 39 GHZ, and the like. For a 6th generation (6G) mobile communication technology referred to as a system beyond 5G communication (beyond 5G), in order to achieve a data rate fifty times faster than the 5G mobile communication technology and ultra-low latency one-tenth of the 5G mobile communication technology, implementation of the 6G mobile communication technology in the terahertz band (e.g., the 95 GHz to 3 THz band) is being considered.

In the early phase of the development of the 5G mobile communication technology, in order to support services and satisfy performance requirements of enhanced Mobile BroadBand (eMBB), Ultra Reliable Low Latency Communications (URLLC), and massive Machine-Type Communications (mMTC), there has been ongoing standardization with respect to beamforming and massive multiple input multiple output (MIMO) for mitigating pathloss of radio waves and increasing transmission distances of radio wave in a mmWave band, supporting numerologies (for example, operation of multiple subcarrier spacings) for efficiently utilizing mmWave resources and dynamic operation of slot formats, initial access technologies for supporting multi-beam transmission and broadband, definition and operation of bandwidth part (BWP), new channel coding methods such as a low density parity check (LDPC) code for large-capacity data transmission and a polar code for highly reliable transmission of control information, layer 2 (L2) pre-processing, and network slicing for providing a dedicated network specialized to a specific service.

Currently, there are ongoing discussions about improvement and performance enhancement of initial 5G mobile communication technologies in consideration of services to be supported by the 5G mobile communication technology, and there has been physical layer standardization of technologies such as vehicle-to-everything (V2X) for aiding autonomous vehicles to make driving decisions based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) that is UE-satellite direct communication for providing coverage in an area in which communication with terrestrial networks is unavailable, and positioning.

There has been ongoing standardization of air interface architecture/protocols regarding technologies such as industrial Internet of Things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR), and standardization of system architecture/services regarding a 5G baseline architecture (for example, service based architecture or service based interface) for combining network functions virtualization (NFV) and software-defined networking (SDN) technologies, and mobile edge computing (MEC) for receiving services based on UE positions.

When the 5G mobile communication system is commercialized, a rapid increase in connected devices being connected to communication networks is predicted, and therefore, it is predicted that enhancement of functions and performance of the 5G mobile communication system and integrated operations of the connected devices will be required. To this end, new research is scheduled for extended Reality (XR) for efficiently supporting Augmented Reality (AR), Virtual Reality (VR), Mixed Reality (MR) and the like, 5G performance improvement and complexity reduction by utilizing artificial intelligence (AI) and machine learning (ML), AI service support, metaverse service support, drone communication, and the like.

Such development of the 5G mobile communication system will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of the 6G mobile communication technologies and improving system networks, AI-based communication technology for implementing system optimization by utilizing satellites and AI from a design stage and internalizing end-to-end AI support functions, and next-generation distributed computing technology for implementing services at levels of complexity exceeding the limit of UE operation capability by utilizing ultra-high-performance communication and computing resources.

With recent developments of 5G/6G communication systems in consideration of the environment, there is an increasing necessity for a method for reducing energy consumption or saving energy in a communication system (for example, a UE, a base station, a network, etc.).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method of designing and transmitting a wake-up signal (WUS) for a user equipment (UE) to request on-demand transmission during an on-demand operation to reduce energy consumption of a base station (BS) in a wireless communication system.

Another aspect of the disclosure is to provide a setting method by higher layer signaling (for example, radio resource control (RRC) signaling) for applying an on-demand operation, and may provide a method of activating and deactivating an on-demand operation by higher layer signaling and layer 1 (L1) signaling. Also, a method of designing and transmitting a WUS for a UE to request on-demand transmission may be provided.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, on a cell of a base station, configuration information regarding an uplink (UL) wake up signal (WUS) for at least one cell, transmitting, via physical random access channel (PRACH), the UL WUS based on the configuration information, and receiving an on-demand system information block (SIB) on the at least one cell, based on the UL WUS.

In accordance with another aspect of the disclosure, a method performed by a base station in a wireless communication system is provided. The method includes transmitting, on a cell of the base station, configuration information regarding an uplink (UL) wake up signal (WUS) for at least one cell, to a user equipment, receiving, via physical random access channel (PRACH), the UL WUS based on the configuration information, and transmitting an on-demand system information block (SIB) on the at least one cell, based on the UL WUS.

In accordance with another aspect of the disclosure, a user equipment (UE) in a wireless communication system is provided. The UE includes a transceiver, and at least one processor coupled with the transceiver and configured to receive, on a cell of a base station, configuration information regarding an uplink (UL) wake up signal (WUS) for at least one cell, transmit, via physical random access channel (PRACH), the UL WUS based on the configuration information, and receive an on-demand system information block (SIB) on the at least one cell, based on the UL WUS.

In accordance with another aspect of the disclosure, a base station in a wireless communication system is provided. The base station includes a transceiver, and at least one processor coupled with the transceiver and configured to transmit, on a cell of the base station, configuration information regarding an uplink (UL) wake up signal (WUS) for at least one cell, to a user equipment, receive, via physical random access channel (PRACH), the UL WUS based on the configuration information, and transmit an on-demand system information block (SIB) on the at least one cell, based on the UL WUS.

In accordance with another aspect of the disclosure, one or more non-transitory computer-readable storage media storing one or more computer programs including computer-executable instructions that, when executed by one or more processors of a user equipment (UE) individually or collectively, cause the UE to perform operations are provided. The operations include receiving, on a cell of a base station, configuration information regarding an uplink (UL) wake up signal (WUS) for at least one cell, transmitting, via physical random access channel (PRACH), the UL WUS based on the configuration information, and receiving an on-demand system information block (SIB) on the at least one cell, based on the UL WUS.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain that is a radio resource region in a wireless communication system, according to an embodiment of the disclosure;

FIG. 2 illustrates a slot structure considered in a wireless communication system, according to an embodiment of the disclosure;

FIG. 3 illustrates a time-domain mapping structure of a synchronization signal and an example of a beam sweeping operation, according to an embodiment of the disclosure;

FIG. 4 illustrates a synchronization signal (SS) block considered in a wireless communication system, according to an embodiment of the disclosure;

FIG. 5 illustrates various transmission cases of an SS block in a frequency band of less than 6 GHz considered in a wireless communication system, according to an embodiment of the disclosure;

FIG. 6 illustrates transmission cases of an SS block in a frequency band of 6 GHz or more, considered in a wireless communication system, according to an embodiment of the disclosure;

FIG. 7 illustrates transmission cases of an SS block according to a subcarrier spacing within a time of 5 ms in a wireless communication system, according to an embodiment of the disclosure;

FIG. 8 illustrates examples for describing demodulation reference signal (DMRS) patterns (type 1 and type 2) used for communication between a base station (BS) and a user equipment (UE) in a wireless communication system, according to an embodiment of the disclosure;

FIG. 9 illustrates an example of channel estimation using a DMRS received on one physical uplink shared channel (PUSCH) in a time band of a wireless communication system, according to an embodiment of the disclosure;

FIG. 10 illustrates a method of reconfiguring synchronization signal block (SSB) transmission via dynamic signaling in a wireless communication system, according to an embodiment of the disclosure;

FIG. 11 illustrates a method of reconfiguring a bandwidth part (BWP) and a bandwidth (BW) by dynamic signaling in a wireless communication system, according to an embodiment of the disclosure;

FIG. 12 illustrates a method of reconfiguring discontinuous reception (DRX) by dynamic signaling in a wireless communication system, according to an embodiment of the disclosure;

FIG. 13 is a diagram for describing a discontinuous transmission (DTx) method for saving energy of a BS, according to an embodiment of the disclosure;

FIG. 14 illustrates an example for describing an operation of a BS according to a gNB wake-up signal, according to an embodiment of the disclosure;

FIG. 15 is a diagram illustrating an antenna adaptation method for a BS for energy saving, in a wireless communication system, according to an embodiment of the disclosure;

FIG. 16 is a diagram for describing on-demand SSB operations of a BS and a UE, according to an embodiment of the disclosure;

FIG. 17 is a diagram for describing a secondary cell (SCell) activation/deactivation and on-demand SSB configuration method by a BS, according to an embodiment of the disclosure;

FIG. 18 is a diagram for describing a medium access control control element (MAC CE)-based SCell activation/deactivation and on-demand SSB configuration method by a BS, according to an embodiment of the disclosure;

FIG. 19 is a diagram for describing a structure of a wake-up signal (WUS) for a UE to request an on-demand channel, according to an embodiment of the disclosure;

FIG. 20 is a diagram for describing a structure of a WUS occasion for a UE to request an on-demand channel, according to an embodiment of the disclosure;

FIG. 21 is a flowchart of an energy saving method performed by a UE in a wireless communication system, according to an embodiment of the disclosure;

FIG. 22 is a flowchart of an energy saving method performed by a BS in a wireless communication system, according to an embodiment of the disclosure;

FIG. 23 is a block diagram of a UE, according to an embodiment of the disclosure; and

FIG. 24 is a block diagram of a BS, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

In the drawings, some elements may be exaggerated, omitted, or roughly illustrated. Also, size of each element does not exactly correspond to an actual size of each element. In each drawing, elements that are the same or are in correspondence are rendered the same reference numeral.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein; rather, these embodiments of the disclosure are provided so that this disclosure will be thorough and complete, and will fully convey the concept of the disclosure to one of ordinary skill in the art. The scope of the disclosure is defined by the appended claims. Throughout the specification, like reference numerals refer to like elements. In the descriptions of the disclosure, detailed explanations of the related art are omitted when it is deemed that they may unnecessarily obscure the essence of the disclosure. The terms used in the specification are defined in consideration of functions used in the disclosure, and can be changed according to the intent or commonly used methods of users or operators. Accordingly, definitions of the terms are understood based on the entire descriptions of the disclosure.

A base station is an entity that allocates resources to a terminal, and may be at least one of a next-generation node B (gNode B), an evolved node B (eNode B), a Node B, a base station (BS), a radio access unit, a BS controller, or a node on a network. A terminal may include a user equipment (UE), a mobile station (MS), a cellular phone, a smartphone, a computer, or a multimedia system capable of performing a communication function. In the disclosure, a downlink (DL) is a wireless transmission path of a signal transmitted from a BS to a UE, and an uplink (UL) is a wireless transmission path of a signal transmitted from a UE to a BS. Although the following descriptions may be provided about long term evolution (LTE) or LTE-Advanced (LTE-A) systems as an example, embodiments of the disclosure are also applicable to other communication systems having similar technical backgrounds or channel structure. In an example, a 5th generation (5G) New Radio (NR) mobile communication technology developed after the LTE-A system may be included therein, and hereinafter, 5G may indicate a concept including LTE, LTE-A, and other similar services according to the related art. The disclosure is applicable to other communication systems through modification at the discretion of one of ordinary skill in the art without greatly departing from the scope of the disclosure.

It will be understood that each block of flowchart illustrations, and combinations of blocks in the flowchart illustrations, may be implemented by computer program instructions. The computer program instructions may be provided to a processor of a general-purpose computer, special purpose computer, or other programmable data processing apparatus, such that the instructions, which are executed via the processor of the computer or other programmable data processing apparatus, generate means for performing functions specified in the flowchart block(s). The computer program instructions may also be, for example, stored in a computer-executable or computer-readable memory that may direct the computer or other programmable data processing apparatus to function in a particular manner, such that the instructions stored in the computer-executable or computer-readable memory may produce an article of manufacture including instruction means that perform the functions specified in the flowchart block(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

In addition, each block of the flowchart illustrations may represent a module, segment, or portion of code, which includes one or more executable instructions for performing specified logical function(s). It should also be noted that in some alternative implementations, the functions noted in the blocks may occur out of the order shown. Two blocks shown in succession may in fact be executed substantially concurrently or the blocks may sometimes be executed in the reverse order, depending upon the functionality involved.

The term “ . . . unit” as used in the disclosure refers to a software or hardware component, such as field-programmable gate array (FPGA) or application-specific integrated circuit (ASIC), which performs certain tasks. However, the term “ . . . unit” does not mean to be limited to software or hardware. A “ . . . unit” may be configured to be in an addressable storage medium or configured to operate one or more processors. Thus, according to an embodiment of the disclosure, a “ . . . unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the elements and “ . . . units” may be combined into fewer elements and “ . . . units” or further separated into additional elements and “ . . . units”. Further, the elements and “ . . . units” may be implemented to operate one or more central processing units (CPUs) in a device or a secure multimedia card. Also, according to an embodiment of the disclosure, a “ . . . unit” may include one or more processors.

Embodiments of the disclosure will now be described with reference to the accompanying drawings. Hereinafter, methods and apparatuses proposed in embodiments of the disclosure are not limited to each embodiment, and all or some of one or more embodiments may be combined. Therefore, embodiments of the disclosure are applicable through modification at the discretion of one of ordinary skill in the art without greatly departing from the scope of the disclosure.

In the descriptions of the disclosure, detailed explanations of the related art are omitted when it is deemed that they may unnecessarily obscure the essence of the disclosure. The terms used in the specification are defined in consideration of functions used in the disclosure, and can be changed according to the intent or commonly used methods of users or operators. Definitions of the terms are understood based on the entire descriptions of the disclosure.

Wireless communication systems have been developed from wireless communication systems providing voice centered services in the early stage toward broadband wireless communication systems providing high-speed, high-quality packet data services, like communication standards of high speed packet access (HSPA), long term evolution (LTE or evolved universal terrestrial radio access (E-UTRA)), and LTE-Advanced (LTE-A) of the 3^{rd} Generation Partnership Project (3GPP), high rate packet data (HRPD) and ultra mobile broadband (UMB) of 3GPP2, 802.17e of the Institute of Electrical and Electronic Engineers (IEEE), or the like.

As a representative example of the broadband wireless communication system, the LTE system has adopted an orthogonal frequency division multiplexing (OFDM) scheme in a downlink (DL) and has adopted a single carrier frequency division multiple access (SC-FDMA) scheme in an uplink (UL). The UL refers to a radio link for transmitting data or a control signal from a UE (or an MS) to a BS (or an eNB), and the DL refers to a radio link for transmitting data or a control signal from the BS to the UE. The multiple access schemes identify, for example, data or control information of different users in such a manner that time-frequency resources for carrying the data or control information of the users are allocated and managed not to overlap each other, that is, to achieve orthogonality therebetween.

A post-LTE communication system, i.e., the 5G communication system, is requested to freely reflect various requirements from users and service providers, and thus, has to support services that simultaneously satisfy the various requirements. The services being considered for the 5G communication system include enhanced mobile broadband (eMBB), massive machine-type communication (mMTC), ultra-reliability low-latency communication (URLLC) services, or the like.

The eMBB aims to provide a more improved data rate than a data rate supported by the legacy LTE, LTE-A, or LTE-Pro. For example, in the 5G communication system, the eMBB should be able to provide a peak data rate of 20 Gbps in a DL and a peak data rate of 10 Gbps in an UL at one BS. The 5G communication system has to simultaneously provide the peak data rate and an increased user-perceived data rate of a UE. In order to satisfy such requirements, there is a need for an improvement in transmission/reception technology including an improved multiple-input multiple-output (MIMO) transmission technology. Also, a data rate required in the 5G communication system may be satisfied by using a frequency bandwidth wider than 20 MHz in the 3 GHz to 6 GHz or 6 GHz or more frequency band, instead of the LTE transmitting a signal by using maximum 20 MHz in the 2 GHz band.

The mMTC is being considered to support application services such as IoT in the 5G communication system. In order to efficiently provide the IoT, the mMTC may require the support for a large number of terminals in a cell, improved coverage for a terminal, improved battery time, reduced costs of a terminal, and the like. Because the IoT is attached to various sensors and various devices to provide a communication function, the mMTC should be able to support a large number of terminals (e.g., 1,000,000 terminals/km²) in a cell. Also, because a terminal supporting the mMTC is likely to be located in a shadow region not covered by the cell, such as the basement of a building, due to the characteristics of the service, the terminal may require wider coverage than other services provided by the 5G communication system. The terminal supporting the mMTC should be configured as a low-cost terminal and may require a very long battery life time of 10 to 16 years because it is difficult to frequently replace the battery of the terminal.

The URLLC refers to cellular-based wireless communication services used for mission-critical purposes. For example, services for remote control of robots or machinery, industrial automation, unmanned aerial vehicles, remote health care, emergency alerts, and the like may be considered. The URLLC should provide communications providing very low latency and very high reliability. For example, a service supporting the URLLC should satisfy air interface latency of less than 0.5 milliseconds, and simultaneously has a requirement for a packet error rate of 10⁻⁵ or less. Thus, for the service supporting the URLLC, the 5G system should provide a transmit time interval (TTI) smaller than other services and allocate wide resources in a frequency band so as to ensure reliability of a communication link.

The three services of the 5G communication system (hereinafter, also referred to as the 5G system), i.e., the eMBB, the URLLC, and the mMTC, may be multiplexed and transmitted in one system. Here, in order to satisfy different requirements of the services, the services may use different transceiving schemes and different transceiving parameters.

Hereinafter, a frame structure of the 5G system will be described in detail with reference to drawings. As a wireless communication system to which the disclosure is applied, a configuration of the 5G system will be described as an example for convenience of description, but embodiments of the disclosure may be applied to a system higher than the 5G system or other communication systems in an equal or similar manner.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

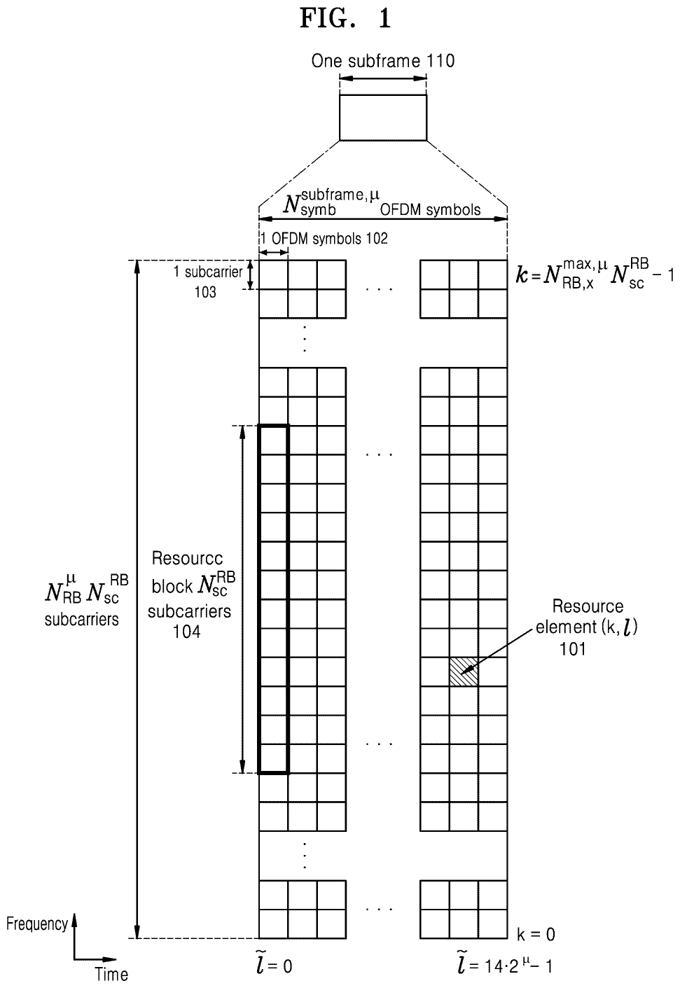

FIG. 1 illustrates a basic structure of a time-frequency domain that is a radio resource region in a wireless communication system, according to an embodiment of the disclosure.

Referring to FIG. 1, a horizontal axis represents a time domain and a vertical axis represents a frequency domain. A basic unit of a resource in the time and frequency domains is a resource element (RE) 101 which may be defined as one orthogonal frequency division multiplexing (OFDM) symbol (or discrete Fourier transform spread OFDM (DFT-s-OFDM) symbol) 102 on the time axis and one subcarrier 103 on the frequency axis. N_{SC}^{RB} (for example, 12) consecutive REs, which RB indicate the number of subcarriers per resource block (RB) in the frequency domain, may constitute one RB 104. Also, N_{symb}^{subframe,μ} consecutive OFDM symbols, which indicate the number of symbols per subframe according to a configuration value u with respect to a subcarrier spacing in the time domain, may constitute one subframe 110.

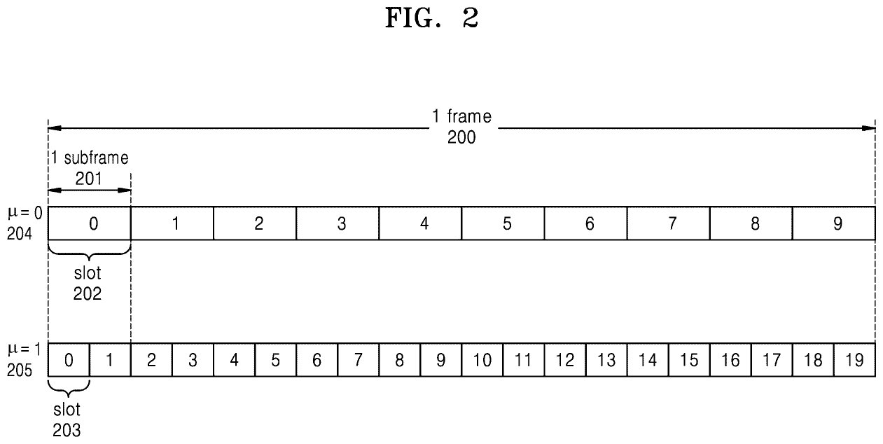

FIG. 2 illustrates a slot structure considered in a wireless communication system, according to an embodiment of the disclosure.

FIG. 2 illustrates an example of the slot structure which includes a frame 200, a subframe 201, and slots 202 and 203. One frame 200 may be defined as 10 ms. One subframe 201 may be defined as 1 ms, and thus, one frame 200 may consist of 10 subframes 201. One slot 202 or 203 may be defined as 14 OFDM symbols (that is, the number of symbols per one slot (N_{symb}^{slot}) is 14). One subframe 201 may consist of one slot 202 or a plurality of slots (including slot 203 for example), and the number of slots per one subframe 201 may vary according to u 204 or 205 which is a configuration value with respect to a subcarrier spacing (SCS).

Slot structures of a case of μ=0 204 and a case of μ=1 205 as an SCS configuration value are illustrated. In the case of μ=0 204, one subframe 201 may consist of one slot 202, and in the case of μ=1 205, one subframe 201 may consist of two slots (including slot 203 for example). As the number of slots (Nₛₗₒₜ^{subframe,μ}) per one subframe may vary according to a configuration value μ with respect to a subcarrier spacing, the number of slots per one frame (Nₛₗₒₜ^{frame,μ}) may also vary accordingly. For example, Nₛₗₒₜ^{subframe,μ} and Nₛₗₒₜ^{frame,μ} according to each subcarrier spacing configuration value u may be defined as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

In the 5G wireless communication system, a synchronization signal block (SSB) (also referred to as an SS block or SS/PBCH block) may be transmitted for an initial access of a UE, and may include a primary synchronization signal (PSS), a secondary synchronization signal (SSS), and a physical broadcast channel (PBCH).

In an initial access stage in which the UE accesses a system, the UE may first obtain a DL time and a frequency domain synchronization from a synchronization signal via a cell search, and may obtain cell identifier (ID). The synchronization signal may include a PSS and an SSS. The UE may receive a PBCH transmitting a master information block (MIB) from a BS, and thus, may obtain transception-related system information including a system bandwidth or related control information, and basic parameter values. Based on the information, the UE may perform decoding on a physical downlink control channel (PDCCH) and a physical downlink shared channel (PDSCH), and thus, may obtain a system information block (SIB). The UE may exchange ID-related information of the UE with the BS via a random access operation, may pass through registration and authentication processes, and may initially access a network. In addition, the UE may receive an SIB transmitted from the BS, and thus, may obtain cell-common transception-related control information. The cell-common transception-related control information may include random access-related control information, paging-related control information, common control information for various physical channels, etc.

A synchronization signal is a reference signal with respect to a cell search, and a subcarrier spacing appropriate for a channel environment (for example, phase noise) for each frequency band may be applied to the synchronization signal. In a case of a data channel or a control channel, in order to support various services as described above, a subcarrier spacing may differ, according to service types.

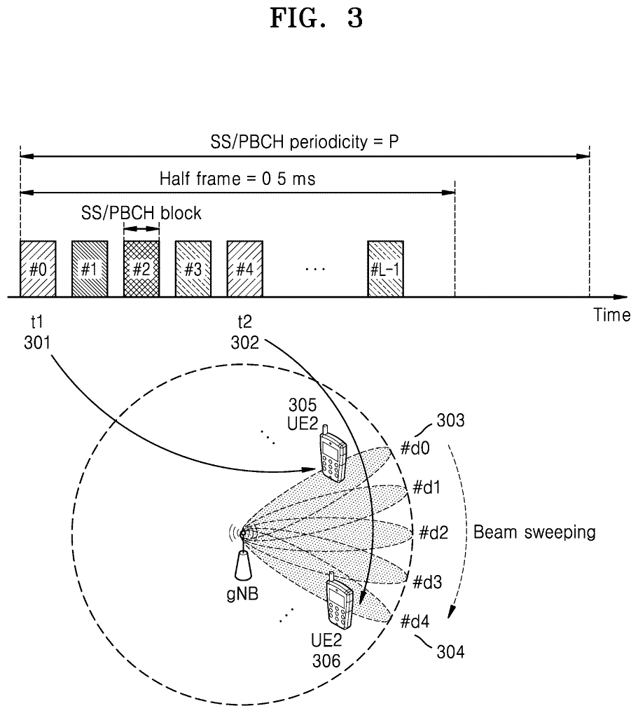

FIG. 3 illustrates a time-domain mapping structure of a synchronization signal and an example of a beam sweeping operation, according to an embodiment of the disclosure.

For the purpose of description, elements may be defined as follows.
PSS: A signal that is a reference for DL time/frequency synchronization provides some information of cell ID.
SSS: A signal that is a reference for DL time/frequency synchronization provides other information of cell ID. In addition, the SSS may function as a reference signal (RS) for demodulation of a PBCH.
PBCH: Provides an MIB that is essential system information requested by a UE to transmit or receive a data channel and a control channel. The essential system information may include search space-related control information indicating radio resource mapping information of a control channel, scheduling control information about a separate data channel to transmit system information, a system frame number (SFN) that is a frame-unit index for a timing reference, or the like.
SS/PBCH block: The SS/PBCH block consists of N OFDM symbols, and corresponds to a combination of the PSS, the SSS, and the PBCH. In a case of a system to which a beam sweeping technology is applied, the SS/PBCH block is a minimum unit to which beam sweeping is applied. In the 5G system, N=4. The BS may transmit up to L SS/PBCH blocks, and the L SS/PBCH blocks may be mapped into a half frame (0.5 ms). The L SS/PBCH blocks are periodically repeated in units of preset periodicity P. The periodicity P may be informed from the BS to the UE by signaling. If there is no separate signaling with respect to the periodicity P, the UE applies a pre-agreed default value.

Referring to FIG. 3, FIG. 3 illustrates an example in which beam sweeping is applied in units of SS/PBCH blocks, according to a flow of time. In the example of FIG. 3, UE 1 305 receives a SS/PBCH block by using a beam radiated in a direction #d0 303 due to beamforming applied to a SS/PBCH block #0 at a t1-time point 301. UE 2 306 receives a SS/PBCH block by using a beam radiated in a direction #d4 304 due to beamforming applied to a SS/PBCH block #4 at a time point t2 302. The UE may obtain an optimal synchronization signal via a beam radiated from the BS in a direction where the UE is positioned. In an example, it may be difficult for the UE 1 305 to obtain time/frequency synchronization and the essential system information from the SS/PBCH block via the beam radiated in the direction #d4 304 distant from a position of the UE 1 305.

In addition to the initial access procedure, the UE may receive an SS/PBCH block so as to determine whether a radio link quality of a current cell is maintained at a preset level or higher. Also, in a handover procedure in which the UE moves access from the current cell to a neighboring cell, the UE may receive an SS/PBCH block of the neighboring cell so as to determine a radio link quality of the neighboring cell and obtain time/frequency synchronization of the neighboring cell.

A cell initial access operation procedure of the 5G wireless communication system will be described in detail with reference to the drawings.

A synchronization signal is a reference signal with respect to a cell search, and a subcarrier spacing appropriate for a channel environment (for example, phase noise) for each frequency band may be applied to the synchronization signal to be transmitted. A 5G BS may transmit a plurality of SS blocks according to the number of analog beams to be operated. For example, a PSS and an SSS are transmitted by being mapped to 12 RBs, and a PBCH may be transmitted by being mapped to 24 RBs. Hereinafter, a structure in which a synchronization signal and a PBCH are transmitted in the 5G communication system will be described.

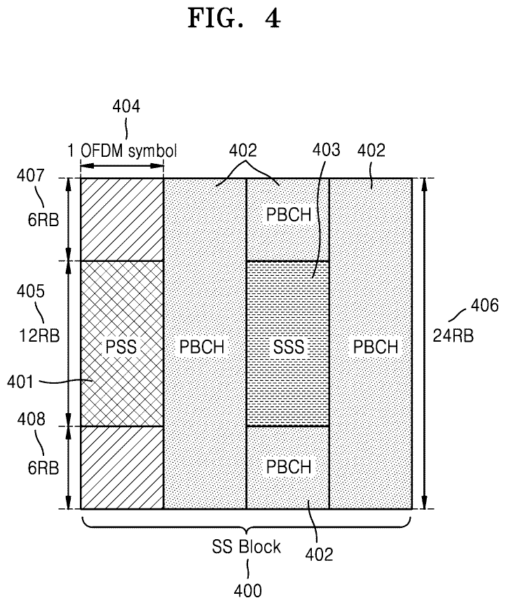

FIG. 4 illustrates an SS block considered in a wireless communication system, according to an embodiment of the disclosure.

Referring to FIG. 4, an SS block 400 may include a PSS 401, an SSS 403, and a PBCH 402.

The SS block 400 may be mapped to four OFDM symbols 404 on a time axis. In an embodiment, the PSS 401 and the SSS 403 may be transmitted on 12 RBs 405 on a frequency axis and on each of first and third OFDM symbols on the time axis. For the 5G system, for example, a total of 1008 different cell IDs may be defined. According to a physical cell ID (PCI) of a cell, the PSS 401 may have three different values, and the SSS 403 may have 336 different values. The UE may obtain one of (336×3=) 1008 cell IDs by detecting and combining the PSS 401 and the SSS 403. This may be represented by Equation 1 below.

$${N}_{ID}^{cell} = 3 {N}_{ID}^{( 1 )} + {N}_{ID}^{( 2 )} \qquad Equation 1$$

Where, N_{ID}⁽¹⁾ may be estimated from the SSS 403 and may have a value between 0 and 335. N_{ID}⁽²⁾ may be estimated from the PSS 401 and may have a value between 0 and 2. The UE may estimate the N_{ID}^{(cell)} value that is a cell ID, according to a combination of N_{ID}⁽¹⁾ and N_{ID}⁽²⁾.

The PBCH 402 may be transmitted on a resource of 24 RBs 406 on the frequency axis and second to fourth OFDM symbols of the SS block on the time axis, excluding 12 RBs 405 in the middle, on which the SSS 403 is transmitted. Both side 6 RBs 407 and 408 of the third OFDM symbol of the SS block excluding the 12 RBs 405 on which the SSS 403 is transmitted may be included in transmission of the PBCH 402. The PBCH 402 may, for example, include a PBCH payload and a PBCH demodulation reference signal (DMRS), and various pieces of system information referred to as an MIB may be transmitted in the PBCH payload. For example, the MIB may include information as in Table 2 below.

TABLE 2

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}

SS block information: Offset of a frequency domain of a SS block may be indicated via 4-bit ssb-SubcarrierOffset in the MIB. An index of the SS block including the PBCH 402 may be indirectly obtained by decoding the PBCH DMRS and the PBCH 402. According to an embodiment, in a frequency band of less than 6 GHZ, 3 bits obtained by decoding the PBCH DMRS may indicate the index of the SS block, and in a frequency band of 6 GHz or more, a total of 6 bits including 3 bits obtained by decoding the PBCH DMRS and 3 bits included in the PBCH payload and obtained by decoding the PBCH 402 may indicate the index of the SS block including the PBCH 402.
PDCCH configuration information: A subcarrier spacing of a common DL control channel may be indicated via 1 bit (subCarrierSpacingCommon) in the MIB, and time-frequency resource configuration information of a control resource set (CORESET) and a search space (SS) may be indicated via 8 bits (pdcch-ConfigSIB1).
SFN: 6 bits (systemFrameNumber) in the MIB may be used to indicate a part of an SFN. 4 bits of a least significant bit (LSB) of the SFN may be included in the PBCH payload, and the UE may indirectly obtain 4 bits of the LSB by decoding the PBCH 402.
Timing information in a radio frame: 1 bit (half frame) included in the index of the synchronization signal block and the PBCH payload and obtained by decoding the PBCH, and the UE may indirectly identify whether the synchronization signal block is transmitted in a first or second half frame of the radio frame.

As a transmission bandwidth (12 RBs 405) of the PSS 401 and the SSS 403 is different from a transmission bandwidth (24 RBs 406) of the PBCH 402, both side 6 RBs 407 and 408 excluding 12 RBs in the middle, on which the PSS 401 is transmitted, exist on the first OFDM symbol on which the PSS 401 is transmitted in the transmission bandwidth of the PBCH 402, and both side areas may be used in transmission of another signal or may be empty.

SS blocks may be transmitted by using a same analog beam. For example, all the PSS 401, the SSS 403, and the PBCH 402 may be transmitted by the same beam. The analog beam has a characteristic in that the analog beam cannot be differently applied on a frequency axis, and thus, the same analog beam may be applied in all frequency-axis RBs in a specific OFDM symbol to which a specific analog beam is applied. All four OFDM symbols on which the PSS 401, the SSS 403, and the PBCH 402 are transmitted may be transmitted by the same analog beam.

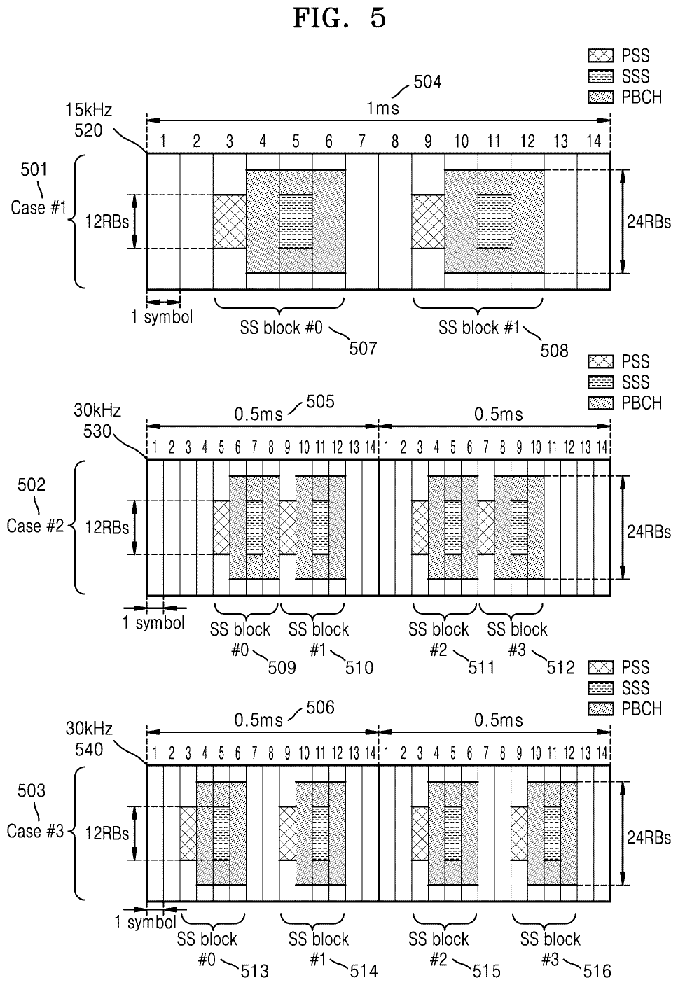

FIG. 5 illustrates various transmission cases of an SS block in a frequency band of less than 6 GHz considered in a wireless communication system, according to an embodiment of the disclosure.

Referring to FIG. 5, in the frequency band of less than 6 GHZ (or, frequency range 1 (FR1), e.g., 410 MHz to 7125 MHz) in the 5G communication system, a 15 kHz-subcarrier spacing (SCS) 520 and 30 kHz-SCSs 530 and 540 may be used to transmit SS blocks. One transmission case (e.g., case #1 501) with respect to an SS block may exist in the 15 kHz-SCS 520, and two transmission cases (e.g., case #2 502 and case #3 503) with respect to an SS block may exist in the 30 kHz-SCSs 530 and 540.

Referring to FIG. 5, in the case #1 501 in the 15 kHz-SCS 520, a maximum of two SS blocks may be transmitted within a time of 1 ms 504 (corresponding to a one slot length when one slot consists of 14 OFDM symbols). In the examples of FIG. 5, SS block #0 507 and SS block #1 508 are illustrated. In an example, the SS block #0 507 may be mapped to four consecutive symbols from a third OFDM symbol, and SS block #1 508 may be mapped to four consecutive symbols from a ninth OFDM symbol.

Different analog beams may be applied to the SS block #0 507 and the SS block #1 508. The same beam may be applied to third to sixth OFDM symbols onto which the SS block #0 507 is mapped, and the same beam may be applied to ninth to twelfth OFDM symbols onto which the SS block #1 508 is mapped. For 7th, 8th, 13th, and 14th OFDM symbols onto which SS blocks are not mapped, an analog beam may be freely determined, based on a BS determining which beam is to be used.

Referring to FIG. 5, in the case #2 502 in the 30 kHz-SCS 530, a maximum of two SS blocks may be transmitted within a time of 0.5 ms 505 (corresponding to a one slot length when one slot consists of 14 OFDM symbols), and thus, a maximum of four SS blocks may be transmitted within a time of 1 ms (corresponding to a two-slot length when one slot consists of 14 OFDM symbols). FIG. 5 illustrates a case in which SS block #0 509, SS block #1 510, SS block #2 511, and SS block #3 512 are transmitted within a time of 1 ms (i.e., two slots). The SS block #0 509 and the SS block #1 510 may be respectively mapped from a fifth OFDM symbol and a ninth OFDM symbol of a first slot, and the SS block #2 511 and the SS block #3 512 may be respectively mapped from a third OFDM symbol and a seventh OFDM symbol of a second slot.

Different analog beams may be respectively applied to the SS block #0 509, the SS block #1 510, the SS block #2 511, and the SS block #3 512. In an embodiment, the same analog beam may be applied to each of fifth to eighth OFDM symbols of the first slot on which the SS block #0 509 is transmitted, ninth to twelfth OFDM symbols of the first slot on which the SS block #1 510 is transmitted, third to sixth OFDM symbols of the second slot on which the SS block #2 511 is transmitted, and seventh to tenth OFDM symbols of the second slot on which the SS block #3 512 is transmitted. For OFDM symbols onto which SS blocks are not mapped, an analog beam may be freely determined, based on a BS determining which beam is to be used.

Referring to FIG. 5, in the case #3 503 in the 30 kHz-SCS 540, a maximum of two SS blocks may be transmitted within a time of 0.5 ms 506 (corresponding to one slot length when one slot consists of 14 OFDM symbols), and thus, a maximum of four SS blocks may be transmitted within a time of 1 ms (corresponding to a two-slot length when one slot consists of 14 OFDM symbols). FIG. 5 illustrates a case in which SS block #0 513, SS block #1 514, SS block #2 515, and SS block #3 516 are transmitted within a time of 1 ms (i.e., two slots). The SS block #0 513 and the SS block #1 514 may be respectively mapped from a third OFDM symbol and a ninth OFDM symbol of a first slot, and the SS block #2 515 and the SS block #3 516 may be respectively mapped from a third OFDM symbol and a ninth OFDM symbol of a second slot.

Different analog beams may be respectively applied to the SS block #0 513, the SS block #1 514, the SS block #2 515, and the SS block #3 516. As illustrated in the examples, the same analog beam may be used for four OFDM symbols on which SS blocks are respectively transmitted, and for OFDM symbols onto which SS blocks are not mapped, an analog beam may be freely determined, based on a BS determining which beam is to be used.

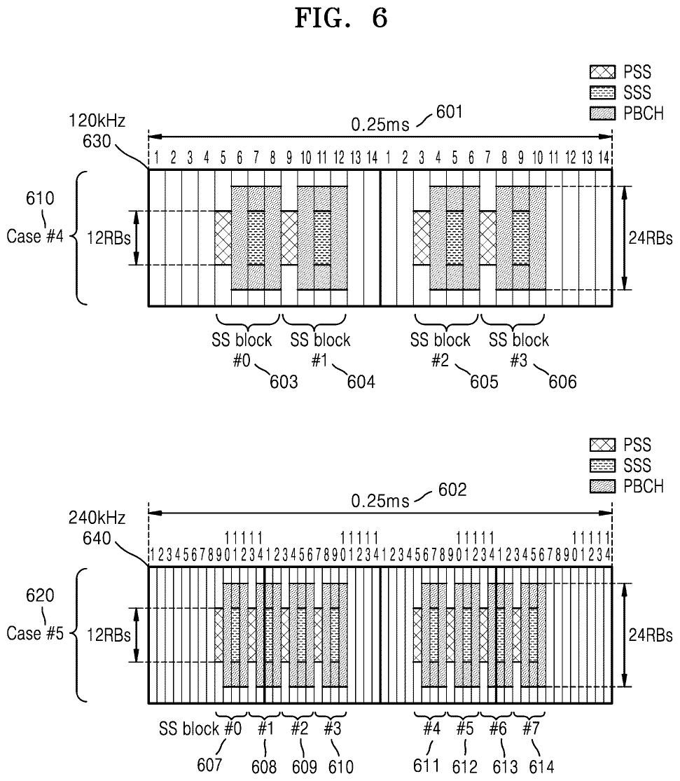

FIG. 6 illustrates transmission cases of an SS block in a frequency band of 6 GHz or more, considered in a wireless communication system, according to an embodiment of the disclosure.

Referring to FIG. 6, in the frequency band of 6 GHz or more (or, FR2, e.g., 24250 MHz to 52600 MHZ) in the wireless communication system, a subcarrier spacing of 120 kHz 630 as in an example of case #4 610 and a subcarrier spacing of 240 kHz 640 as in an example of case #5 620 may be used to transmit SS blocks.

In the case #4 610 in the 120 kHz-SCS 630, a maximum of four SS blocks may be transmitted within a time of 0.25 ms 601 (corresponding to a two-slot length when one slot consists of 14 OFDM symbols). FIG. 6 illustrates an example in which SS block #0 603, SS block #1 604, SS block #2 605, and SS block #3 606 are transmitted within 0.25 ms (i.e., two slots). The SS block #0 603 and the SS block #1 604 may be, for example, mapped onto four consecutive symbols from a fifth OFDM symbol and four consecutive symbols from a ninth OFDM symbol of a first slot, respectively, and the SS block #2 605 and the SS block #3 606 may be mapped onto four consecutive symbols from a third OFDM symbol and four consecutive symbols from a seventh OFDM symbol of a second slot, respectively.

As illustrated in the examples above, different analog beams may be respectively applied to the SS block #0 603, the SS block #1 604, the SS block #2 605, and the SS block #3 606. The same analog beam may be used for four OFDM symbols on which SS blocks are respectively transmitted, and for OFDM symbols onto which SS blocks are not mapped, an analog beam may be freely determined, based on a BS determining which beam is to be used.

In the case #5 620 in the 240 kHz-SCS 640, a maximum of eight SS blocks may be transmitted within a time of 0.25 ms 602 (corresponding to a four-slot length when one slot consists of 14 OFDM symbols). FIG. 6 illustrates an example in which SS block #0 607, SS block #1 608, SS block #2 609, SS block #3 610, SS block #4 611, SS block #5 612, SS block #6 613, and SS block #7 614 are transmitted within 0.25 ms (i.e., four slots).

In an embodiment, the SS block #0 607 and the SS block #1 608 may be mapped onto four consecutive symbols from a ninth OFDM symbol and four consecutive symbols from a thirteenth OFDM symbol of a first slot, respectively, the SS block #2 609 and the SS block #3 610 may be mapped onto four consecutive symbols from a third OFDM symbol and four consecutive symbols from a seventh OFDM symbol of a second slot, respectively, the SS block #4 611, the SS block #5 612, and the SS block #6 613 may be mapped onto four consecutive symbols from a fifth OFDM symbol, four consecutive symbols from a ninth OFDM symbol, and four consecutive symbols from a thirteenth OFDM symbol of a third slot, respectively, and the SS block #7 614 may be mapped onto four consecutive symbols from a third OFDM symbol of a fourth slot.

As illustrated in the examples, different analog beams may be respectively applied to the SS block #0 607, the SS block #1 608, the SS block #2 609, the SS block #3 610, the SS block #4 611, the SS block #5 612, the SS block #6 613, and the SS block #7 614. The same analog beam may be used for four OFDM symbols on which SS blocks are respectively transmitted, and for OFDM symbols onto which SS blocks are not mapped, an analog beam may be freely determined, based on a BS determining which beam is to be used.

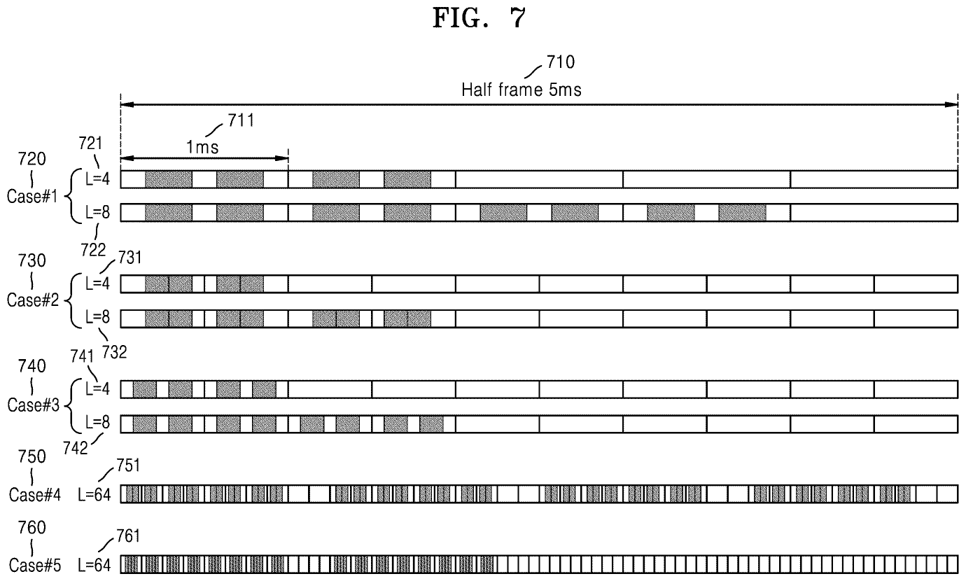

FIG. 7 illustrates transmission cases of an SS block according to a subcarrier spacing within a time of 5 ms in a wireless communication system, according to an embodiment of the disclosure.

Referring to FIG. 7, in the 5G communication system, an SS block may be periodically transmitted in units of a time interval of 5 ms 710 (corresponding to 5 subframes 711 or a half frame).

In a frequency band of 3 GHz or less, a maximum of four SS blocks may be transmitted within a time of 5 ms 710. In a frequency band of more than 3 GHz to 6 GHz or less, a maximum of eight SS blocks may be transmitted. In a frequency band of more than 6 GHZ, a maximum of 64 SS blocks may be transmitted. Subcarrier spacings of 15 kHz and 30 kHz may be used in a frequency band of 6 GHz or less.

In case #1 720 of FIG. 7, a subcarrier spacing may be 15 kHz and a subframe may consist of one slot, as in the case #1 501 of FIG. 5. In the case #1 720, an SS block may be mapped onto a first slot and a second slot in the frequency band of 3 GHz or less, and thus, a maximum of four SS blocks 721 may be transmitted, and an SS block may be mapped onto first, second, third, and fourth slots in the frequency band of more than 3 GHz to 6 GHz or less, and thus, a maximum of eight SS blocks 722 may be transmitted. In case #2 730 or case #3 740 of FIG. 7, a subcarrier spacing may be 30 kHz and a subframe may consist of two slots, as in the case #2 502 or the case #3 503 of FIG. 5. In the case #2 730 or the case #3 740, an SS block may be mapped from a first slot in the frequency band of 3 GHz or less, and thus, a maximum of four SS blocks 731 or 741 may be transmitted, and an SS block may be mapped from first and third slots in the frequency band of more than 3 GHz to 6 GHz or less, and thus, a maximum of eight SS blocks 732 or 742 may be transmitted.

Subcarrier spacings of 120 kHz and 240 kHz may be used in the frequency band of more than 6 GHZ. In case #4 750 of FIG. 7, a subcarrier spacing may be 120 kHz and a time of 0.25 ms may correspond to two slots, as in the case #4 610 of FIG. 6. In the case #4 750, an SS block may be mapped from 1st, 3^{rd}, 5^{th}, 7^{th}, 11^{th}, 13^{th}, 15^{th}, 17^{th}, 21^{st}, 23^{rd}, 25^{th}, 27^{th}, 31^{st}, 33^{rd}, 35^{th}, and 37^{th} slots in the frequency band of more than 6 GHz, and thus, a maximum of 64 SS blocks 751 may be transmitted. In case #5 760 of FIG. 7, a subcarrier spacing may be 240 kHz and a time of 0.25 ms may correspond to four slots, as in the case #5 620 of FIG. 6. In the case #5 760, an SS block may be mapped from 1^{st}, 5^{th}, 9^{th}, 13^{th}, 21^{st}, 25^{th}, 29^{th}, and 33^{rd} slots in the frequency band of more than 6 GHZ, and thus, a maximum of 64 SS blocks 761 may be transmitted.

A UE may perform decoding on a PDCCH and a PDSCH, based on system information included in a received MIB, and then may obtain an SIB. The SIB may include at least one of information related to a UL cell bandwidth, a random access parameter, a paging parameter, or a parameter related to UL power control.

The UE may establish a radio link with a network via a random access procedure, based on system information and synchronization with the network, which are obtained during a cell search process with respect to a cell. A contention-based random access scheme or a contention-free random access scheme may be used. When the UE performs cell selection and reselection during an initial access stage with respect to the cell, the contention-based random access scheme may be used to switch from an RRC_IDLE state to an RRC_CONNECTED state. The contention-free random access may be used to reconfigure UL synchronization when DL data has arrived, when handover is performed, or when positioning is performed. Table 3 below shows conditions (events) that trigger a random access procedure in the 5G system.

TABLE 3
- Initial access from RRC_IDLE;
- RRC Connection Re-establishment procedure;
- DL or UL data arrival during RRC_CONNECTED when UL
synchronisation status is “non-
synchronised”;
- UL data arrival during RRC_CONNECTED when there are no
PUCCH resources for SR available;
- SR failure;
- Request by RRC upon synchronous reconfiguration (e.g. handover);
- RRC Connection Resume procedure from RRC_INACTIVE;
- To establish time alignment for a secondary TAG;
- Request for Other SI;
- Beam failure recovery;
- Consistent UL LBT failure on SpCell.

Hereinafter, a measurement time configuration method for SS block (or SSB)-based radio resource management (RRM) of the 5G wireless communication system will now be described.

A UE receives, by higher layer signaling, a configuration of MeasObjectNR of MeasObjectToAddModList as a configuration for SSB-based intra/inter-frequency measurements and channel state information-reference signal (CSI-RS)-based intra/inter-frequency measurements. For example, MeasObjectNR may be configured as Table 4 below.

TABLE 4

| | |
|---|---|
| MeasObjectNR ::= | SEQUENCE { |

| | |
|---|---|
| ssbFrequency ARFCN-ValueNR | OPTIONAL, |
| -- Cond SSBorAssociatedSSB | SubcarrierSpacing |

ssbSubcarrierSpacing

| | | |
|---|---|---|
| OPTIONAL, | -- Cond SSBorAssociatedSSB | SSB-MTC |

smtc1

| OPTIONAL, | -- Cond SSBorAssociatedSSB | |
|---|---|---|
| smtc2 | | SSB-MTC2 |
| OPTIONAL, | -- Cond IntraFreqConnected | ARFCN-ValueNR |

reffreqCSI-RS

| | |
|---|---|
| OPTIONAL, | -- Cond CSI-RS |

| | |
|---|---|
| referenceSignalConfig | ReferenceSignalConfig, |

| absThreshSS-BlocksConsolidation | | ThresholdNR |
|---|---|---|
| OPTIONAL, | -- Need R | |
| absThreshCSI-RS-Consolidation | | ThresholdNR |
| OPTIONAL, | -- Need R | |
| nrofSS-BlocksToAverage | | INTEGER (2..maxNrofSS-BlocksToAverage) |
| OPTIONAL, | -- Need R | INTEGER (2..maxNrofCSI-RS-ResourcesToAverage) |

nrofCSI-RS-ResourcesToAverage

| | |
|---|---|
| OPTIONAL, | -- Need R |

| | |
|---|---|
| quantityConfigIndex | INTEGER (1..maxNrofQuantity Config), |

| | |
|---|---|
| offsetMO | Q-OffsetRangeList, |

| cellsToRemoveList | | PCI-List |
|---|---|---|
| OPTIONAL, | -- Need N | CellsToAddModList |

cellsToAddModList

| OPTIONAL, | -- Need N | |
|---|---|---|
| blackCellsToRemoveList | | PCI-RangeIndexList |
| OPTIONAL, | -- Need N | SEQUENCE (SIZE (1..maxNrofPCI-Ranges)) OF PCI-RangeElement |

blackCellsToAddModList

| | | |
|---|---|---|
| OPTIONAL, | -- Need N | PCI-RangeIndexList |

whiteCellsToRemoveList

| | | |
|---|---|---|
| OPTIONAL, | -- Need N | SEQUENCE (SIZE (1..maxNrofPCI-Ranges)) OF PCI-RangeElement |

whiteCellsToAddModList

| | |
|---|---|
| OPTIONAL, | -- Need N |

```
  ...,
  [[
```

| | |
|---|---|
| freqBundIndicatorNR | FreqBandIndicatorNR |

| | |
|---|---|
| OPTIONAL, | -- Need R |

| | |
|---|---|
| measCycleSCell | ENUMERATED (sf160, sf256, sf320, sf512, sf640, sf1024, sf1280} |

| | |
|---|---|
| OPTIONAL, | -- Need R |

```
  ]]
  [[
```

| smtc3list-r16 | | SSB-MTC3List-r16 |
|---|---|---|
| OPTIONAL, | -- Need R | |
| rmtc-Config-r16 | | SetupRelease {RMTC-Config-r16} |
| OPTIONAL, | -- Need M | |

| | |
|---|---|
| t312-r16 | SetupRelease { T312-r16 } |

| | |
|---|---|
| OPTIONAL | -- Need M |

]]
}

The terms in Table 4 may indicate that functions below are performed. However, the disclosure is not limited thereto.
ssbFrequency: May configure a frequency of a synchronization signal related to MeasObjectNR.
ssbSubcarrierSpacing: Configures a subcarrier spacing of SSB. FR1 may apply only 15 kHz or 30 kHz, and FR2 may apply only 120 kHz or 240 kHz.
smtc1: May indicate an SS/PBCH block measurement timing configuration, may configure a primary measurement timing configuration, and may configure a timing offset and duration for SSB.
smtc2: May configure a secondary measurement timing configuration for SSB related to MeasObjectNR having PCI listed in pci-List.

MeasObjectNR may be configured by another higher layer signaling. For example, an SS/PBCH block measurement timing configuration (SMTC) may be configured for the UE through SIB2 for intra-frequency, inter-frequency, and inter-radio access technology (RAT) cell reselection or through reconfiguration WithSync for an NR primary secondary cell (PSCell) change and an NR primary cell (PCell) change, and in addition, the SMTC may be configured for the UE by SCellConfig for NR secondary cell (SCell) addition.

The UE may be configured with a first SMTC according to periodictiyAndOffset (providing periodicity and offset) via smtc1 configured by higher layer signaling, for SSB measurement. According to an embodiment, a first subframe of each SMTC occasion may start from an SFN and a subframe of SpCell satisfying conditions of Table 5 below.

TABLE 5

```
SFN mod T = (FLOOR (Offset/10));
if the Periodicity is larger than sf5:
  subframe = Offset mod 10;
else:
  subframe = Offset or (Offset +5);
with T = CEIL(Periodicity/10).
```

If smtc2 is configured, the UE may be configured with an additional SMTC according to periodicity of configured smtc2 and an offset and duration of smtc1, for cells indicated by a value of pci-List of smtc2 in same MeasObjectNR. In addition, the UE may be configured with smtc and may measure SSB via smtc3list for smtc2-LP (with long periodicity) and integrated access and backhaul-mobile termination (IAB-MT), for a same frequency (e.g., a frequency for intra frequency cell reselection) or different frequencies (e.g., frequencies for inter frequency cell reselection). According to an embodiment, the UE may not consider an SSB transmitted in a subframe other than an SMTC occasion for SSB-based RRM measurement in configured ssbFrequency.

A BS may use various multi-transmit/receive point (TRP) operating methods according to a serving cell configuration and a physical cell identifier (PCI) configuration. Among them, there may be two methods of operating two TRPs when the two TRPs that are physically spaced apart from each other have different PCIs.

### [Operating Method 1]

Two TRPs having different PCIs may be operated with two serving cell configurations.

The BS may configure, via Operating Method 1 channels and signals transmitted from the different TRPs via the different serving cell configurations. In other words, each TRP has an independent serving cell configuration, and frequency band values FrequencyInfoDL indicated by DownlinkConfigCommon in each serving cell configuration may indicate at least a portion of a band which partially overlaps. As the several TRPs operate based on a plurality of ServCellIndex (e.g., ServCellIndex #1 and ServCellIndex #2), each TRP may use a separate PCI. In other words, the BS may allocate one PCI per ServCellIndex.

In this case, if a plurality of SSBs are transmitted from TRP 1 and TRP 2, the SSBs have different PCIs (e.g., PCI #1 and PCI #2), and the BS may appropriately select a value of ServCellIndex indicated by a cell parameter in quasi co-location (QCL)-Info to map PCI matching each TRP, and may designate SSB transmitted from one of TRP 1 and TRP 2 as source reference RS of QCL configuration information. However, according to the configuration, as one serving cell configuration available for carrier aggregation (CA) of the UE is applied to multiple TRPs, the degree of freedom of CA configuration may be limited or a signaling load may be increased.

### [Operating Method 2]

Two TRPs having different PCIs may be operated with one serving cell configuration.

The BS may configure, by Operating Method 2, channels and signals transmitted from different TRPs via one serving cell configuration. As the UE operates based on one ServCellIndex (e.g., ServCellIndex #1), it is impossible for the UE to recognize PCI (e.g., PCI #2) allocated to a second TRP. Operating Method 2 may provide more flexibility in CA configuration, compared to Operating Method 1 described above, but when several SSBs are transmitted from TRP 1 and TRP 2, the SSBs have different PCIs (e.g., PCI #1 and PCI #2) and it may be impossible for the BS to map PCI (e.g., PCI #2) of the second TRP via ServCellIndex indicated by a cell parameter in QCL-Info. The BS is able to only designate SSB transmitted from TRP 1 as source reference RS of QCL configuration information, and may not be able to designate SSB transmitted from TRP 2.

In Operating Method 1, multi-TRP operation may be performed on two TRPs having different PCIs via an additional serving cell configuration without an additional support of rules, but Operating Method 2 may be performed based on an additional UE capability report and BS configuration information below.

### UE Capability Report for Operating Method 2

The UE may report to the BS via UE capability that the BS may configure PCI of a serving cell and another additional PCI, by higher layer signaling from the BS. The UE capability may include X1 and X2 that are two independent numbers, or X1 and X2 may be reported as independent UE capabilities.
X1 indicates a maximum number of additional PCIs configurable for the UE, the PCIs being different from the PCI of the serving cell, and a time domain position and periodicity of SSB corresponding to the additional PCI may be equal to those of SSB of the serving cell.
X2 indicates a maximum number of additional PCIs configurable for the UE, the PCIs being different from the PCI of the serving cell, and a time domain position and periodicity of SSB corresponding to the additional PCI may be different from those of SSB of the serving cell reported via X1.
According to the definitions, PCIs corresponding to values reported as X1 and X2 shall not be simultaneously configured.
The values reported as X1 and X2 via the UE capability report may each have a value of one integer from 0 to 7.
The values reported as X1 and X2 may be differently reported in FR1 and FR2.

### Higher Layer Signaling Configuration for Operating Method 2

The UE may be configured, from the BS, with SSB-MTCAdditionalPCI-r17 that is higher layer signaling, based on the UE capability report, the higher layer signaling may at least include a plurality of additional PCIs having different values from the serving cell, SSB transmission power corresponding to each additional PCI, and ssb-PositionInBurst corresponding to each additional PCI, and the number of additional PCIs that may be maximally configured may be 7.
The UE may assume that the SSB corresponding to the additional PCI having the different value from the serving cell has a central frequency, a subcarrier spacing, and a subframe number offset that are the same as the SSB of the serving cell.
The UE may assume that a reference RS (e.g., SSB or CSI-RS) corresponding to the PCI of the serving cell is always connected to an activated transmission configuration indication (TCI) state, and when there are one or more additionally configured PCIs having different values from the serving cell, the UE may assume that only one PCI among the configured PCIs is connected to the activated TCI state.
If the UE is configured with two different coresetPoolIndexes, a reference RS corresponding to the PCI of the serving cell is connected to one or more activated TCI states, and a reference RS corresponding to the additionally configured PCI having a different value from the serving cell is connected to the one or more activated TCI states, the UE may expect that the activated TCI state(s) connected to the PCI of the serving cell is connected to one of the two coresetPoolIndexes and the activated TCI state(s) connected to the additionally configured PCI having a different value from the serving cell is connected to the remaining one of the two coresetPoolIndexes.

The UE capability report and the higher layer signaling of the BS for Operating Method 2 described above may configure an additional PCI having a different value from the PCI of the serving cell. When the configuration does not exist, the SSB corresponding to the additional PCI having a different value from the PCI of the serving cell that is unable to be designated by the source reference RS may be used to designate the source reference RS of the QCL configuration information. Unlike SSB that may be configured to be used for RRM, mobility, or handover, based on configuration information about SSB that may be configured in smtc1 and smtc2 that are the higher layer signaling, the SSB corresponding to the additional PCI having a different value from the PCI of the serving cell may be used to serve as a QCL source RS for supporting multi-TRP operations having different PCIs.

Next, a DMRS that is one of reference signals in the 5G system will now be described in detail.

The DMRS may include several DMRS ports, and each of the ports may maintain orthogonality by using code division multiplexing (CDM) or frequency division multiplexing (FDM) so as not to interfere with each other. However, the term “DMRS” may be expressed in different terms depending on a user's intention and a purpose of a reference signal. The term “DMRS” is merely illustrative of specific examples to easily facilitate description and understanding of the disclosure, and are not intended to limit the scope of the disclosure. It will be obvious to one of ordinary skill in the art to which the disclosure belongs that the disclosure is applicable to any reference signal, based on the technical idea of the disclosure.

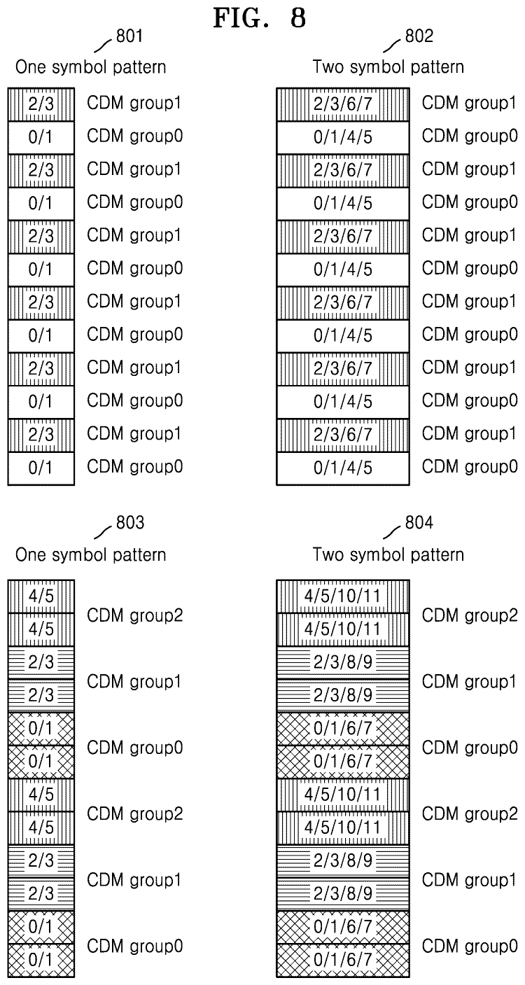

FIG. 8 illustrates examples for describing DMRS patterns (type 1 and type 2) used for communication between a BS and a UE in a wireless communication system, according to an embodiment of the disclosure.

In the 5G system, two DMRS patterns may be supported. FIG. 8 illustrates two DMRS patterns.

Referring to FIG. 8, a DMRS type 1 801 and 802 may specifically include a one symbol pattern 801 (i.e., the DMRS type 1 801) and a two symbol pattern 802 (i.e., the DMRS type 1 802). The DMRS type 1 801 and 802 are DMRS patterns of a comb 2 structure and may include two CDM groups, and FDM may be applied to different CDM groups.

Two DMRS ports may be distinguished for a same CDM group as frequency CDM is applied to the one symbol pattern 801 (i.e., the DMRS type 1 801), and thus, a total of four orthogonal DMRS ports may be configured. The one symbol pattern 801 (i.e., the DMRS type 1 801) may include a DMRS port ID mapped onto each CDM group (e.g., a DMRS port ID for a DL may be indicated by a number+1000). Four DMRS ports may be distinguished for a same CDM group as time/frequency CDM is applied to the two symbol pattern 802 (i.e., the DMRS type 1 802), and thus, a total of eight orthogonal DMRS ports may be configured. The two symbol pattern 802 (i.e., the DMRS type 1 802) may include a DMRS port ID mapped onto each CDM group (e.g., a DMRS port ID for a DL may be indicated by a number+1000).

FIG. 8 illustrates a DMRS type 2 803 and 804. The DMRS type 2 803 and 804 is a DMRS pattern having a structure in which frequency domain orthogonal cover codes (FD-OCC) are applied to a frequency-neighboring subcarrier, and may include three CDM groups, and FDM may be applied to different CDM groups.

Two DMRS ports may be distinguished for a same CDM group as frequency CDM is applied to one symbol pattern 803 (i.e., the DMRS type 2 803), and thus, a total of six orthogonal DMRS ports may be configured. The one symbol pattern 803 (i.e., the DMRS type 2 803) may include a DMRS port ID mapped onto each CDM group (e.g., a DMRS port ID for a DL may be indicated by a number+1000). Four DMRS ports may be distinguished for a same CDM group as time/frequency CDM is applied to two symbol pattern 804 (i.e., the DMRS type 2 804), and thus, a total of 12 orthogonal DMRS ports may be configured. The two symbol pattern 804 (i.e., the DMRS type 2 804) may include a DMRS port ID mapped onto each CDM group (e.g., a DMRS port ID for a DL may be indicated by a number+1000).

As described above, in an NR system, two different DMRS patterns (e.g., the DMRS type 1 801 and 802 or the DMRS type 2 803 and 804) may be configured. Also, it may be configured whether each DMRS pattern is the one symbol pattern 801 (i.e., the DMRS type 1 801) or 803 (i.e., the DMRS type 2 803) or the neighboring two symbol pattern 802 (i.e., the DMRS type 1 802) or 804 (i.e., the DMRS type 2 804). Also, in the NR system, not only a DMRS port number is scheduled, but also the number of CDM groups scheduled for PDSCH rate matching may be configured by signaling. In addition, for cyclic prefix-based orthogonal frequency division multiplexing (CP-OFDM), both the two DMRS patterns described above may be supported in DL and UL, and for discrete Fourier transform spread OFDM (DFT-S-OFDM), only the DMRS type 1 801 and 802 among the DMRS patterns described above may be supported in UL.

Also, an additional DMRS may be supported to be configurable. A front-loaded DMRS refers to a first DMRS transmitted/received on the frontmost symbol in a time domain, and an additional DMRS refers to a DMRS transmitted/received on a symbol behind the front-loaded DMRS in the time domain. In the NR system, the number of additional DMRS may be set from minimally 0 up to 3. When the additional DMRS is configured, a same pattern as the front-loaded DMRS may be assumed. When the additional DMRS is additionally configured, it may be assumed that same DMRS information as the front-loaded DMRS is configured for the additional DMRS. For example, when at least one of information about whether a DMRS pattern type is type 1 or type 2, information about whether a DMRS pattern is a one symbol pattern or an neighboring two symbol pattern, or information about the number of DMRS ports and used CDM groups is indicated for the front-loaded DMRS, the same DMRS information as the front-loaded DMRS may be configured for the additional DMRS in a case where the additional DMRS is additionally configured.

According to an embodiment of the disclosure, the DL DMRS configuration described above may be configured by RRC signaling as in Table 6 below.

TABLE 6

| DMRS-DownlinkConfig ::= | SEQUENCE { | |
|---|---|---|
| dmrs-Type | ENUMERATED {type2} | OPTIONAL, -- Need S |
| dmrs-AdditionalPosition | ENUMERATED {pos0, pos1, pos3} | OPTIONAL, -- Need S |
| maxLength | ENUMERATED {len2} | OPTIONAL, -- Need S |
| scramblingID0 | INTEGER (0..65535) | OPTIONAL, -- Need S |
| scramblingID1 | INTEGER (0..65535) | OPTIONAL, -- Need S |

| | |
|---|---|
| phaseTrackingRS | SetupRelease {PTRS-DownlinkConfig} OPTIONAL, -- Need M |

...
}

Here, a DMRS type may be configured via dmrs-Type, additional DMRS OFDM symbols may be configured via dmrs-AdditionalPosition, and a one symbol pattern or a two symbol pattern may be configured via maxLength. A scrambling ID may be configured via scramblingID0 and scramblingID1, and a phase tracking reference signal (PTRS) may be configured via phaseTrackingRS.

Also, the UL DMRS configuration described above may be configured by RRC signaling as in Table 7 below.

TABLE 7

| DMRS-UplinkConfig ::= | SEQUENCE { | |
|---|---|---|
| dmrs-Type | ENUMERATED {type2} | OPTIONAL, -- Need S |
| dmrs-AdditionalPosition | ENUMERATED {pos0, pos1, pos3} | OPTIONAL, -- Need R |
| phaseTrackingRS | SetupRelease { PTRS-UplinkConfig } | OPTIONAL, -- Need M |
| maxLength | ENUMERATED {len2} | OPTIONAL, -- Need S |
| transformPrecodingDisabled | SEQUENCE { | |
| scramblingID0 | INTEGER (0..65535) | OPTIONAL, -- Need S |
| scramblingID1 | INTEGER (0..65535) | OPTIONAL, -- Need S |

| | |
|---|---|
| ... | OPTIONAL, -- Need R |

}

| transformPrecodingEnabled | SEQUENCE { | |
|---|---|---|
| nPUSCH-Identity | INTEGER (0..1007) | OPTIONAL, -- Need S |
| sequenceGroupHopping | ENUMERATED {disabled} | OPTIONAL, -- Need S |
| sequenceHopping | ENUMERATED {enabled} | OPTIONAL, -- Need S |

| | |
|---|---|
| ... | OPTIONAL, -- Need R |

```
  }
  ...
}
```

Here, a DMRS type may be configured via dmrs-Type, additional DMRS OFDM symbols may be configured via dmrs-AdditionalPosition, PTRS may be configured via phaseTrackingRS, and a one symbol pattern or a two symbol pattern may be configured via maxLength. Scrambling IDs may be configured via scramblingID0 and scramblingID1, a cell ID for DFT-s-OFDM may be configured via nPUSCH-Identity, sequence group hopping may be disabled via sequenceGroupHopping, and sequence hopping may be enabled via sequenceHopping.

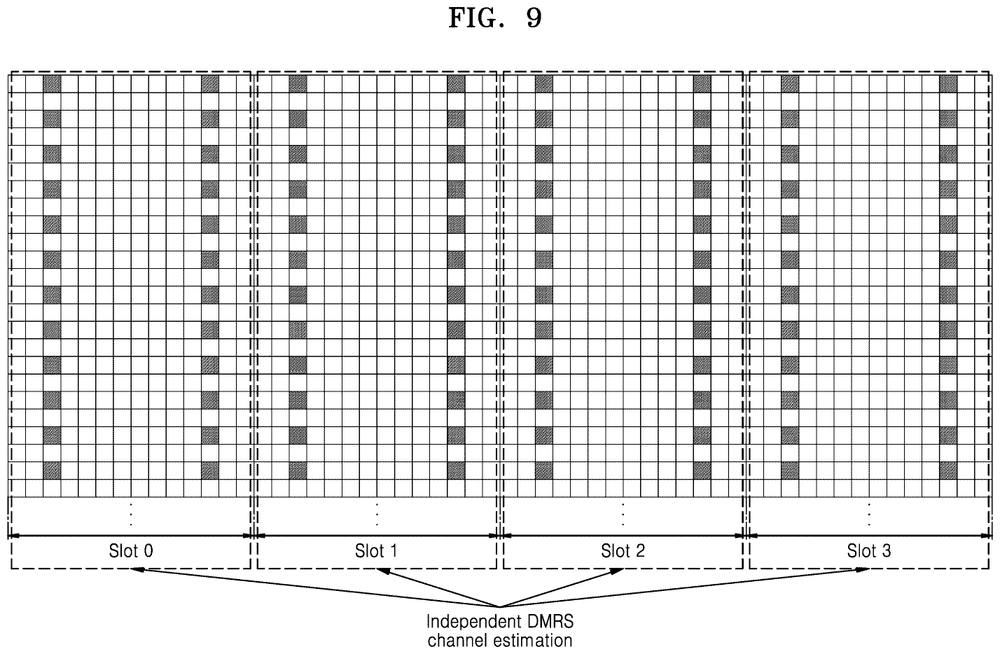

FIG. 9 illustrates an example of channel estimation using a DMRS received on one physical uplink shared channel (PUSCH) in a time band of a wireless communication system, according to an embodiment of the disclosure.

Referring to FIG. 9, when performing channel estimation for data decoding by using DMRS, the channel estimation may be performed within a precoding resource block group (PRG) that is a bundling unit, by using physical resource block (PRB) bundling linked to a system band, in a frequency band. Also, in a time unit, the channel estimation may be performed by assuming that precoding is the same for DMRS received on only one PUSCH.

A time domain resource allocation (TDRA) method for a data channel in the 5G communication system will now be described. A BS may configure a UE with a TDRA information table for a PDSCH and a PUSCH, by higher layer signaling (e.g., RRC signaling).

For the PDSCH, the BS may configure a table consisting of up to maxNrofDL-Allocations=17 entries, and for the PUSCH, the BS may configure a table consisting of up to maxNrofUL-Allocations=17 entries. TDRA may include at least one of a PDCCH-to-PDSCH slot timing (corresponding to a time interval in a slot unit between a time point when the PDCCH is received and a time point when the PDSCH scheduled by the received PDCCH is transmitted, indicated by K0), or a PDCCH-to-PUSCH slot timing (corresponding to a time interval in a slot unit between a time point when the PDCCH is received and a time point when the PUSCH scheduled by the received PDCCH is transmitted, indicated by K2), information about a location and length of a starting symbol on which the PDSCH or PUSCH is scheduled within a slot, or a mapping type of the PDCH or PUSCH.

According to an embodiment, the TDRA information for the PDSCH may be configured for the UE by RRC signaling as shown in Table 8 below.

TABLE 8
PDSCH-TimeDomainResourceAllocationList information element

PDSCH-TimeDomainResourceAllocationList ::= SEQUENCE (SIZE(1..maxNrofDL-Allocations)) OF PDSCH-
TimeDomainResourceAllocation
PDSCH-TimeDomainResourceAllocation ::= SEQUENCE {

| | |
|---|---|
| k0 | INTEGER(0..32) OPTIONAL, -- Need S |
| mappingType | ENUMERATED {typeA, typeB}, |
| startSymbolAndLength | INTEGER (0..127) |
| repetitionNumber | ENUMERATED {n2, n3, n4, n5, n6, n7, n8, n16} OPTIONAL, -- Cond |

Formats1-0and1-1
}

Here, k0 may indicate the PDCCH-to-PDSCH timing (i.e., a slot offset between downlink control information (DCI) and PDSCH scheduled therefor) in a slot unit, mappingType may indicate a PDSCH mapping type, startSymbolAndLength may indicate a starting symbol and length of PDSCH, and repetitionNumber may indicate the number of PDSCH transmission occasions according to a slot-based repetition scheme. This is merely an example, and a plurality of pieces of information described above may be indicated in a time unit other than a slot unit. For example, k0 may be in a symbol unit.

According to an embodiment of the disclosure, the TDRA information for the PUSCH may be configured for the UE by RRC signaling as shown in Table 9 below.

TABLE 9
PUSCH-TimeDomainResourceAllocation information element

PUSCH-TimeDomainResourceAllocationList ::= SEQUENCE (SIZE(1..maxNrofUL-Allocations)) OF PUSCH-
TimeDomainResourceAllocation
PUSCH-TimeDomainResourceAllocation ::= SEQUENCE {

| | |
|---|---|
| k2 | INTEGER(0..32) OPTIONAL, -- Need S |
| mappingType | ENUMERATED {typeA, typeB}, |
| startSymbolAndLength | INTEGER (0..127) |

}
PUSCH-Allocation-r16 ::= SEQUENCE {

| | | |
|---|---|---|
| mappingType-r16 | ENUMERATED {typeA, typeB} | OPTIONAL, -- Cond NotFormat01- |
| 02-Or-TypeA | | |
| startSymbolAndLength-r16 | INTEGER (0..127) | OPTIONAL, -- Cond NotFormat01-02-Or-TypeA |
| startSymbol-r16 | INTEGER (0..13) | OPTIONAL, -- Cond RepTypeB |
| length-r16 | INTEGER (1..14) | OPTIONAL, -- Cond RepTypeB |

| | |
|---|---|
| numberOfRepetitions-r16 | ENUMERATED {nl, n2, n3, n4, n7, n8, n12, n16} OPTIONAL, -- Cond |

Format01-02
...
}

Here, k2 may indicate the PDCCH-to-PUSCH timing (i.e., a slot offset between DCI and PUSCH scheduled therefor in a slot unit, mappingType may indicate a PUSCH mapping type, startSymbolAndLength or StartSymbol and length may indicate a starting symbol and length of PUSCH, and numberOfRepetitions may indicate the number of repetitions to be applied to PUSCH transmission. This is merely an example, and a plurality of pieces of information described above may be indicated in a time unit other than a slot unit. For example, k2 may be in a symbol unit.

The BS may indicate the UE with at least one of entries of the table about the TDRA information by L1 signaling (e.g., DCI) (e.g., may indicate via “TDRA” field in the DCI). The UE may obtain the TDRA information for the PDSCH or PUSCH, based on the DCI received from the BS.

Transmission of PUSCH in the 5G system will now be described in detail. The PUSCH transmission may be dynamically scheduled by UL grant in DCI (e.g., referred to as dynamic grant (DG)-PUSCH) or may be scheduled by configured grant Type 1 or configured grant Type 2 (e.g., referred to as configured grant (CG)-PUSCH). Dynamic scheduling for the PUSCH transmission may be indicated by DCI format 0_0 or 0_1.

The PUSCH transmission of the configured grant Type 1 may be semi-statically configured via reception of configuredGrantConfig including rrc-ConfiguredUplinkGrant of Table 10 by higher layer signaling, without receiving the UL grant in the DCI. The PUSCH transmission of the configured grant Type 2 may be semi-persistently scheduled by the UL grant in the DCI after reception of configuredGrantConfig not including rrc-ConfiguredUplinkGrant of Table 10, by higher layer signaling.

According to an embodiment, when the PUSCH transmission is configured by configured grant, parameters to be applied to the PUSCH transmission may be configured via configuredGrantConfig that is higher layer signaling of Table 10, excluding specific parameters (e.g., dataScramblingIdentityPUSCH, txConfig, codebookSubset, maxRank, or scaling of UCI-OnPUSCH) provided via pusch-Config of Table 11, which is higher layer signaling. For example, when the UE is provided with transformPrecoder in the configuredGrantConfig that is higher layer signaling of Table 10, the UE may apply tp-pi2BPSK in the pusch-Config of Table 11 with respect to the PUSCH transmission based on the configured grant.

TABLE 10
ConfiguredGrantConfig

| ConfiguredGrantConfig ::= | SEQUENCE { | |
|---|---|---|
| frequencyHopping | ENUMERATED {intraSlot, interSlot} | OPTIONAL, -- Need S, |
| cg-DMRS-Configuration | DMRS-UplinkConfig. | |
| mcs-Table | ENUMERATED {qam256, qam64LowSE} | OPTIONAL, - Need S |
| mcs-TableTransformPrecoder | ENUMERATED {qam256, qam64LowSE} | OPTIONAL, -- Need S |
| uci-OnPUSCH | SetupRelease { CG-UCI-OnPUSCH } | OPTIONAL, -- Need M |

| | |
|---|---|
| resourceAllocation | ENUMERATED { resourceAllocationType0, resourceAllocationType1, |

dynamicSwitch }.

| rbg-Size | ENUMERATED {config2} | OPTIONAL, -- Need S |
|---|---|---|
| powerControlLoopToUse | ENUMERATED {n0, n1}, | |
| p0-PUSCH-Alpha | P0-PUSCH-AlphaSetId, | |
| transformPrecoder | ENUMERATED {enabled, disabled} | OPTIONAL, -- Need S |
| nrofHARQ-Processes | INTEGER(1..17), | |
| repK | ENUMERATED {n1, n2, n4, n8}, | |
| repK-RV | ENUMERATED {s1-0231, s2-0303, s3-0000} | OPTIONAL, -- Need R |

| | |
|---|---|
| periodicity | ENUMERATED { |

```
  sym2, sym7, sym1x14, sym2x14, sym4x14, sym5x14, sym8x14, sym10x14, sym17x14, sym20x14,
  sym32x14, sym40x14, sym64x14, sym80x14, sym128x14, sym170x14, sym256x14, sym320x14, sym512x14,
  sym640x14, sym1024x14, sym1280x14, sym2560x14, sym5120x14,
  sym6, sym1x12, sym2x12, sym4x12, sym5x12, sym8x12, sym10x12, sym17x12, sym20x12, sym32x12,
  sym40x12, sym64x12, sym80x12, sym128x12, sym170x12, sym256x12, sym320x12, sym512x12, sym640x12,
  sym1280x12, sym2560x12
},
```

| configuredGrantTimer | INTEGER(1..64) | OPTIONAL, -- Need R |
|---|---|---|
| Pre-ConfiguredUplinkGrant | SEQUENCE { | |
| timeDomainOffset | INTEGER (0..5119), | |
| timeDomainAllocation | INTEGER (0..16), | |
| frequencyDomainAllocation | BIT STRING (SIZE(18)). | |
| antennaPort | INTEGER (0..31), | |
| dmrs-SeqInitialization | INTEGER (0..1) | OPTIONAL. -- Need R |
| precodingAndNumberOfLayers | INTEGER (0..63), | |
| srs-ResourceIndicator, | INTEGER (0..16) | OPTIONAL, -- Need R |

| | |
|---|---|
| mesAndTBS | INTEGER (0..31), |
| frequencyHoppingOffset | INTEGER (1..maxNrofPhysicalResourceBlocks−1) OPTIONAL, |

-- Need R

| | |
|---|---|
| pathlossReferenceIndex | INTEGER (0..maxNrofPUSCH-PathlossReferenceRSs−1), |

...

| | |
|---|---|
| } | OPTIONAL, -- Need R |

...
}

Next, a PUSCH transmission method will now be described. A DMRS antenna port for PUSCH transmission may be equal to an antenna port for sounding reference signal (SRS) transmission. The PUSCH transmission may follow a codebook-based transmission method or a non-codebook-based transmission method, according to whether a value of the pusch-Config of Table 11, which is higher layer signaling, is ‘codebook’ or ‘nonCodebook’. As described above, the PUSCH transmission may be dynamically scheduled via the DCI format 0_0 or 0_1, or may be semi-statically configured by the configured grant.

When the UE is configured, via the DCI format 0_0, with scheduling for the PUSCH transmission, the UE may perform beam configuration for the PUSCH transmission by using pucch-spatialRelationInfoID corresponding to a UE-specific (dedicated) PUCCH resource having a lowest ID in an UL bandwidth part (BWP) activated in a serving cell. According to an embodiment of the disclosure, the PUSCH transmission may be performed based on a single antenna port. The UE may not expect the scheduling for the PUSCH transmission via the DCI format 0_0, in a BWP in which a PUCCH resource including pucch-spatialRelationInfo is not configured. If the UE is not configured with txConfig in the pusch-Config of Table 11, the UE may not expect scheduling via the DCI format 0_1.

TABLE 11
PUSCH-Config

| PUSCH-Config ::= | SEQUENCE { | |
|---|---|---|
| dataScramblingIdentityPUSCH | INTEGER (0..1023) | OPTIONAL, -- Need S |

| | |
|---|---|
| txConfig | ENUMERATED {codebook, nonCodebook} OPTIONAL, -- Need S |

```
  dmrs-UplinkForPUSCH-MappingTypeA  SetupRelease { DMRS-UplinkConfig }  OPTIONAL,  -- Need M
  dmrs-UplinkForPUSCH-MappingTypeB  SetupRelease { DMRS-UplinkConfig } OPTIONAL,  -- Need M
```

| | | |
|---|---|---|
| pusch-PowerControl | PUSCH-PowerControl | OPTIONAL, -- Need M |

| | |
|---|---|
| frequencyHopping | ENUMERATED {intraSlot, interSlot} OPTIONAL, -- Need S |
| frequencyHoppingOffsetLists | SEQUENCE (SIZE (1..4)) OF INTEGER (1.. |
| maxNrofPhysicalResourceBlocks−1) | OPTIONAL, -- Need M |
| resourceAllocation | ENUMERATED { resourceAllocationType0, resourceAllocationTypeI, |

dynamicSwitch},

| | |
|---|---|
| pusch-TimeDomainAllocationList | SetupRelease { PUSCH-TimeDomainResourceAllocationList } |

OPTIONAL, -- Need M

| | | |
|---|---|---|
| pusch-AggregationFactor | ENUMERATED { n2, n4, n8 } | OPTIONAL, -- Need S. |
| mcs-Table | ENUMERATED (qam256, qam64LowSE} | OPTIONAL, -- Need S |
| mcs-TableTransformPrecoder | ENUMERATED {qam256. qam64LowSE} | OPTIONAL, -- Need S |
| transformPrecoder | ENUMERATED {enabled, disabled} | OPTIONAL, -- Need S |

```
  codebookSubset ENUMERATED {fullyAndPartialAndNonCoherent, partialAndNonCoherent,nonCoherent}
      OPTIONAL, -- Cond codebookBased
```

| | | |
|---|---|---|
| maxRank | INTEGER (1..4) | OPTIONAL, -- Cond codebookBased |
| rbg-Size | ENUMERATED { config2} | OPTIONAL, -- Need S |
| uci-OnPUSCH | SetupRelease { UCI-OnPUSCH} | OPTIONAL, -- Need M |
| tp-pi2BPSK: | ENUMERATED {enabled} | OPTIONAL, -- Need S |

...
}

Next, codebook-based PUSCH transmission will now be described. The codebook-based PUSCH transmission may be dynamically scheduled via the DCI format 0_0 or 0_1, and may be semi-statically performed based on the configured grant. When the codebook-based PUSCH transmission is dynamically scheduled by the DCI format 0_1 or semi-statically configured by the configured grant, the UE may determine a precoder for the PUSCH transmission, based on an SRS resource indicator (SRI), a transmission precoding matrix indicator (TPMI), and a transmission rank (the number of PUSCH transmission layers).

According to another embodiment, the SRI may be given via a field SRS resource indicator in the DCI or via srs-ResourceIndicator that is higher layer signaling. The UE may be configured with at least one SRS resource, for example, may be configured with up to two SRS resources, during the codebook-based PUSCH transmission. When the UE is provided with the SRI via the DCI, an SRS resource indicated by the SRI may denote an SRS resource corresponding to the SRI, from among SRS resources transmitted before a PDCCH including the SRI. Also, the TPMI and transmission rank may be given via field precoding information and number of layers in the DCI, or may be configured via precodingAndNumberOfLayers that is higher layer signaling. The TPMI may be used to indicate a precoder to be applied to the PUSCH transmission.

The precoder to be used for the PUSCH transmission may be selected from an uplink codebook having the number of antenna ports equal to a value of nrofSRS-Ports in SRS-Config that is higher layer signaling. In the codebook-based PUSCH transmission, the UE may determine a codebook subset, based on the TPMI and the codebookSubset in the pusch-Config that is higher layer signaling. According to another embodiment, the codebookSubset in the pusch-Config that is higher layer signaling may be configured to be one of ‘fullyAndPartialAndNonCoherent’, ‘partialAndNonCoherent’, and ‘nonCoherent’, based on UE capability reported by the UE to the BS.

If the UE reported ‘partialAndNonCoherent’ as the UE capability, the UE may not expect a value of codebookSubset that is higher layer signaling to be configured to ‘fully AndPartialAndNonCoherent’. Also, if the UE reported ‘nonCoherent’ as the UE capability, the UE may not expect the value of codebookSubset that is higher layer signaling to be configured to ‘fully AndPartialAndNonCoherent’ or ‘partialAndNonCoherent’. If nrofSRS-Ports in SRS-ResourceSet that is higher layer signaling indicates two SRS antenna ports, the UE may not expect the value of codebookSubset that is higher layer signaling to be configured to ‘partialAndNonCoherent’.

The UE may be configured with one SRS resource set in which a value of usage in SRS-ResourceSet that is higher layer signaling is configured to ‘codebook’, and one SRS resource in the SRS resource set may be indicated via SRI. If several SRS resources are configured in the SRS resource set in which the value of usage in SRS-ResourceSet that is higher layer signaling is configured to ‘codebook’, the UE may expect a value of nrofSRS-Ports in SRS-Resource that is higher layer signaling to be the same for all SRS resources.

The UE transmits, to the BS, one or a plurality of SRS resources included in the SRS resource set in which the value of usage is configured to ‘codebook’ according to higher layer signaling, and the BS may select one of the SRS resources transmitted by the UE and may, for example, indicate the UE to perform the PUSCH transmission, by using transmission beam information of the selected SRS resource. According to an embodiment of the disclosure, in the codebook-based PUSCH transmission, SRI may be used as information for selecting an index of one SRS resource, and may be included in the DCI. In addition, the BS may include, in the DCI, information indicating the TPMI and rank to be used by the UE for the PUSCH transmission and transmit the same. The UE may perform the PUSCH transmission by applying the precoder indicated by the TPMI and rank indicated based on a transmission beam of the SRS resource, by using the SRS resource indicated by the SRI.

Next, non-codebook-based PUSCH transmission will now be described. The non-codebook-based PUSCH transmission may be dynamically scheduled via the DCI format 0_0 or 0_1, or may be semi-statically performed based on the configured grant. When at least one SRS resource is configured in the SRS resource set in which a value of usage in SRS-ResourceSet that is higher layer signaling is configured to ‘nonCodebook’, the UE may receive scheduling for the non-codebook-based PUSCH transmission via the DCI format 0_1.

With respect to the SRS resource set in which the value of usage in SRS-ResourceSet that is higher layer signaling is configured to ‘nonCodebook’, the UE may be configured with one non-zero power (NZP) CSI-RS resource associated with one SRS resource set. The UE may perform calculation with respect to a precoder for SRS transmission via measurement on the NZP CSI-RS resource configured in association with to the SRS resource set. If a difference between a last reception symbol on an aperiodic NZP CSI-RS resource associated with the SRS resource set and a first symbol of aperiodic SRS transmission in the UE is less than specific symbols (e.g., 42 symbols), the UE may not expect information about the precoder for SRS transmission to be updated.

When a value of resourceType in SRS-ResourceSet that is higher layer signaling is configured as ‘aperiodic’, NZP CSI-RS associated with SRS-ResourceSet may be indicated via an SRS request that is a field in a DCI format 0_1 or 1_1. According to an embodiment, when the NZP CSI-RS resource associated with SRS-ResourceSet is an aperiodic NZP CSI resource and a value of the field SRS request in the DCI format 0_1 or 1_1 is not ‘00’, it may indicate that NZP CSI-RS associated with SRS-ResourceSet is present. The DCI may not indicate cross carrier or cross BWP scheduling. If the value of SRS request indicates the presence of NZP CSI-RS, the NZP CSI-RS may be positioned in a slot in which PDCCH including an SRS request field is transmitted. TCI states configured in a scheduled subcarrier may not be configured to be QCL-TypeD.

If the SRS resource set is periodically or semi-persistently configured, the NZP CSI-RS associated with the SRS resource set may be indicated via associatedCSI-RS in SRS-ResourceSet that is higher layer signaling. With respect to the non-codebook-based transmission, the UE may not expect spatialRelationInfo that is higher layer signaling for the SRS resource and associatedCSI-RS in SRS-ResourceSet that is higher layer signaling to be configured together.

When the UE is configured with a plurality of SRS resources, the UE may determine the precoder and a transmission rank to be applied to the PUSCH transmission, based on SRI indicated by the BS. According to another embodiment of the disclosure, the SRI may be indicated via a field SRS resource indicator in the DCI or may be configured via srs-ResourceIndicator that is higher layer signaling. As in the codebook-based PUSCH transmission, when the UE receives the SRI via the DCI, the SRS resource indicated by the SRI may denote an SRS resource corresponding to the SRI from among SRS resources transmitted prior to the PDCCH including the SRI. The UE may use one or a plurality of SRS resources for SRS transmission, and the maximum number of SRS resources capable of being simultaneously transmitted on a same symbol in one SRS resource set may be determined by UE capability reported by the UE to the BS. The SRS resources simultaneously transmitted by the UE may occupy a same RB. The UE may configure one SRS port for each SRS resource. Only one SRS resource set, in which the value of usage in SRS-ResourceSet that is higher layer signaling is configured to be ‘nonCodebook’, may be configured, and up to four SRS resources for the non-codebook-based PUSCH transmission may be configured.

The BS may transmit, to the UE, one NZP CSI-RS associated with an SRS resource set, and the UE may calculate a precoder to be used to transmit one or a plurality of SRS resources in the SRS resource set, based on a result measured when receiving the NZP CSI-RS. The UE applies the calculated precoder when transmitting, to the BS, one or plurality of SRS resources in the SRS resource set, in which the usage is configured to be ‘nonCodebook’, and the BS may select one or plurality of SRS resources from among the received one or plurality of SRS resources. In the non-codebook-based PUSCH transmission, the SRI may denote an index capable of representing one SRS resource or a combination of a plurality of SRS resources, and the SRI may be included in the DCI. The number of SRS resources indicated in the SRI transmitted by the BS may, for example, correspond to the number of transmission layers of the PUSCH, and the UE may transmit the PUSCH by applying, to each layer, the precoder applied for the SRS resource transmission.

Hereinafter, a single transport block (TB) transmission method via multiple slots and repetitive transmission of UL data channel (PUSCH) in the 5G system will now be described. The 5G system may support two types of repetitive transmission methods of the UL data channel (e.g., PUSCH repetitive transmission type A and a PUSCH repetitive transmission type B) and TB processing over multi-slot (TBoMS) for transmitting a single TB on a PUSCH over multiple slots. Also, the UE may be configured with one of the PUSCH repetitive transmission types A and B by higher layer signaling. The UE may be configured with numberOfSlotsTBoMS via a resource allocation table, and thus, may transmit TBoMS.

### PUSCH Repetitive Transmission Type A

As described above, a starting symbol and length of an UL data channel may be determined via the TDRA method in one slot, and the BS may indicate the UE with the number of repetitive transmissions by higher layer signaling (e.g., RRC signaling) or L1 signaling (for example, DCI). The number N of slots configured as numberOfSlotsTBoMS to determine TBS is 1.
Based on the number of repetitive transmissions indicated by the BS, the UE may repetitively transmit, in consecutive slots, the UL data channel having a starting symbol and length equal to the starting symbol and length of the UL data channel configured above. According to an embodiment, in a slot configured via DL by the BS to the UE or when at least one symbol from among symbols in a slot for UL data channel repetitive transmission configured via DL for the UE is configured, the UE may omit UL data channel transmission in the corresponding slot. For example, the UE may not transmit a UL data channel within the number of repetitive transmissions of the UL data channel. On the other hand, the UE supporting Rel-17 UL data repetitive transmission may determine an available slot for a slot in which UL data repetitive transmission is possible, and may count the number of transmissions in the slot determined to be the available slot, during UL data channel repetitive transmission. When the UL data channel repetitive transmission determined as the available slot is omitted, the omitted UL data channel repetitive transmission may be postponed and then repeatedly transmitted through a transmittable slot. A redundancy version may be applied according to a redundancy version pattern configured for each n^{th} PUSCH transmission occasion by using Table 12 below.

### PUSCH Repetitive Transmission Type B

As described above, the starting symbol and length of the UL data channel may be determined via the TDRA method in one slot, and the BS may transmit, to the UE, the number of repetitive transmissions numberofrepetitions by higher layer signaling (e.g., RRC signaling) or L1 signaling (e.g., DCI). According to an embodiment of the disclosure, the number N of slots configured as numberOfSlotsTBoMS to determine TBS is 1.
First, based on the starting symbol and length of the UL data channel configured above, nominal repetition of the UL data channel may be determined as below. Here, the nominal repetition may denote a resource of a symbol configured by the BS for PUSCH repetitive transmission, and the UE may determine the resource that may be used as UL in the configured nominal repetition. In this case, a slot in which n^{th} nominal repetition starts is provided according to

$${K}_{s} + ⌊ \frac{S + n \cdot L}{{N}_{symb}^{slot}} ⌋ ,$$

and a symbol on which the nominal repetition starts from the starting slot may be given according to mod (S+n·L, N_{symb}^{slot}). A slot in which the n^{th} nominal repetition ends is given according to

$${K}_{s} + ⌊ \frac{S + ( n + 1 ) \cdot L - 1}{{N}_{symb}^{slot}} ⌋$$

and a symbol on which the nominal repetition ends in the last slot may be given according to mod S+(n+1)·L−1, N_{symb}^{slot}) Here, n=0, . . . , numberofrepetitions-1, S may indicate the starting symbol of the configured UL data channel, and L may indicate the symbol length of the configured UL data channel. Kₛ may indicate a slot in which PUSCH transmission starts, and N_{symb}^{slot} may indicate the number of symbols per slot.
The UE may determine an invalid symbol for the PUSCH repetitive transmission type B. A symbol configured via downlink by tdd-UL-DL-ConfigurationCommon or tdd-UL-DL-ConfigurationDedicated may be determined to be the invalid symbol for the PUSCH repetitive transmission type B. In addition, the invalid symbol may be configured based on a higher layer parameter (e.g., InvalidSymbolPattern). For example, the invalid symbol may be configured by providing, via the higher layer parameter (e.g., InvalidSymbolPattern), a symbol level bitmap over one slot or two slots. According to an embodiment of the disclosure, 1 indicated in the bitmap may indicate the invalid symbol. In addition, a cycle and pattern of the bitmap may be configured via a higher layer parameter (i.e., periodicityAndPattern). If the higher layer parameter (i.e., InvalidSymbolPattern) is configured and an InvalidSymbolPatternIndicator-ForDCIFormat0_1 or InvalidSymbolPatternIndicator-ForDCIFormat0_2 parameter indicates 1, the UE may apply an invalid symbol pattern, and when the InvalidSymbolPatternIndicator-ForDCIFormat0_1 or InvalidSymbolPatternIndicator-ForDCIFormat0_2 parameter indicates 0, the UE may not apply the invalid symbol pattern. Alternatively, when the higher layer parameter (for example, InvalidSymbolPattern) is configured and the InvalidSymbolPatternIndicator-ForDCIFormat0_1 or InvalidSymbolPatternIndicator-ForDCIFormat0_2 parameter is not configured, the UE may apply the invalid symbol pattern.
After the invalid symbol is determined in each nominal repetition, the UE may consider symbols obtained by excluding the determined invalid symbol as a valid symbol. When each nominal repetition includes at least one valid symbol, the nominal repetition may include one or more actual repetitions. Here, actual repetition may denote a symbol that is actually used for PUSCH repetitive transmission from among symbols configured for the configured nominal repetition, and may include a set of consecutive valid symbols that may be used for PUSCH repetitive transmission type B in one slot. The UE may omit actual repetition transmission when the actual repetition having one symbol is configured to be valid, except for a case in which a symbol length L of the configured UL data channel is 1. A redundancy version may be applied according to a redundancy version pattern configured for each n^{th} actual repetition by using Table 12 below.

### TB Processing Over Multiple Slots (TBoMS)

As described above, a starting symbol and length of an UL data channel may be determined via the TDRA method in one slot, and the BS may transmit, to the UE, the number of repetitive transmissions by higher layer signaling (e.g., RRC signaling) or L1 signaling (e.g., DCI). According to an embodiment of the disclosure, TBS may be determined by using a value of N of 1 or more, which is the number of slots configured by numberOfSlotsTBoMS.
The UE may transmit, based on the number of repetitive transmissions and the number of slots for determining the TBS received from the BS, an UL data channel having a same starting symbol and length as the UL data channel configured above, in consecutive slots. According to an embodiment of the disclosure, in a slot configured by the BS to the UE via DL or when at least one symbol from among symbols in a slot for UL data channel repetitive transmission configured to the UE is configured via DL, the UE may omit UL data channel transmission in the corresponding slot. For example, the UL data channel transmission omitted in the corresponding slot may be included in the number of repetitive transmissions of the UL data channel, but may not be transmitted.

On the other hand, the UE supporting Rel-17 UL data repetitive transmission may determine an available slot for a slot in which UL data repetitive transmission is possible, and may count the number of transmissions in the slot determined to be the available slot, during UL data channel repetitive transmission. When the UL data channel repetitive transmission determined as the available slot is omitted, the omitted UL data channel repetitive transmission may be postponed and then repeatedly transmitted in a transmittable slot. According to another embodiment, a redundancy version may be applied according to a redundancy version pattern configured for each n^{th} PUSCH transmission occasion by using Table 12 below.

TABLE 12

| | rv_{id} to be applied to n^{th} transmission | | | |
|---|---|---|---|---|
| | occasion (repetition Type A) or TB | | | |
| | processing over multiple slots) or n^{th} actual | | | |
| rv_{id} | repetition (repetition Type B) | | | |
| indicated by | ((n − | ((n − | ((n − | ((n − |
| the DCI | (n mod | (n mod | (n mod | (n mod |
| scheduling | N))/N) mod | N))/N) mod | N))/N) mod | N))/N) mod |
| the PUSCH | 4 = 0 | 4 = 0 | 4 = 0 | 4 = 0 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Hereinafter, a method of determining an UL available slot for single or multi-PUSCH transmission in a 5G system will now be described.

According to an embodiment of the disclosure, when the UE is configured with enable for AvailableSlotCounting, the UE may determine an available slot based on tdd-UL-DL-ConfigurationCommon, tdd-UL-DL-ConfigurationDedicated, ssb-PositionsInBurst, and TDRA information field value, for PUSCH repetitive transmission type A and TBoMS PUSCH transmission. In other words, if at least one symbol configured by TDRA for PUSCH in one slot for PUSCH transmission overlaps at least one symbol for a purpose other than UL transmission, the corresponding slot may be determined as an unavailable slot.

Hereinafter, a method of reducing SSB density by dynamic signaling for BS energy reduction in a 5G system will now be described.

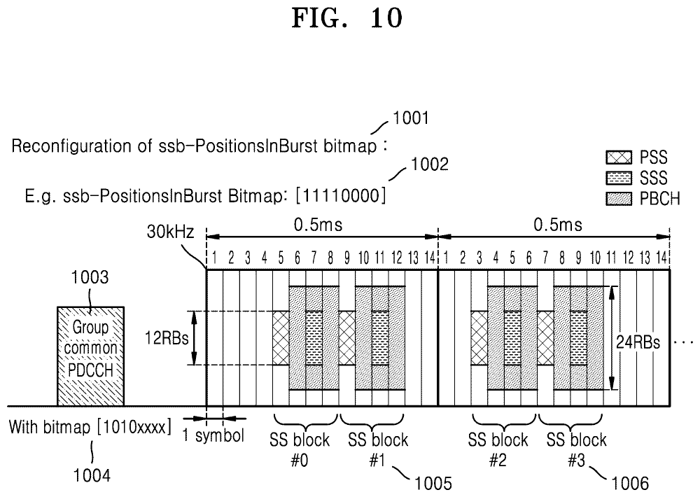

FIG. 10 illustrates a method of reconfiguring SSB transmission via dynamic signaling of a wireless communication system, according to an embodiment of the disclosure.

Referring to FIG. 10, the UE may receive a configuration of ssb-PositionsInBurst=‘11110000’ (1002) from the BS by higher layer signaling (SIB1 or ServingCellConfigCommon) and a maximum of two SS blocks may be transmitted within a time of 0.5 ms (or corresponding to a length of one slot when one slot includes 14 OFDM symbols) in a subcarrier spacing of 30 kHz, and accordingly, the UE may receive four SS blocks within a time of 1 ms (or corresponding to a length of two slots when one slot includes 14 OFDM symbols). Here, in order to reduce density of SSB transmission for energy saving, the BS may reconfigure SSB transmission configuration information by a broadcasting bitmap “1010xxxx” 1004 via group/cell common DCI 1003 having a network energy saving-radio network temporary identifier (nwes-RNTI) (or es-RNTI). Here, transmissions of SS block #1 1005 and SS block #3 1006 may be canceled based on the bitmap 1004 configured via the group/cell common DCI 1003. FIG. 10 illustrates a method 1001 of reconfiguring SSB transmission via bitmap-based group/cell common DCI.

The BS may reconfigure ssb-periodicity configured by higher layer signaling, via the group/cell common DCI 1003. In addition, the BS may additionally configure timer information for indicating an application time for the group/cell common DCI 1003, so as to transmit SSB via SSB transmission information reconfigured by the group/cell common DCI 1003 during a set timer. When the timer stops, the BS may operate according to the SSB transmission information configured by existing higher layer signaling. A configuration may be changed from a normal mode to an energy saving mode via the timer, and accordingly, SSB configuration information may be reconfigured. According to another method, the BS may configure the UE with an application time and period of SSB configuration information reconfigured via the group/cell common DCI 1003, by using offset and duration information. Here, the UE may not monitor the SSB for the duration from a time when an offset is applied at a moment the group/cell common DCI 1003 is received.

A BWP or bandwidth (BW) adaptation method by dynamic signaling for BS energy saving in the 5G system will now be described.

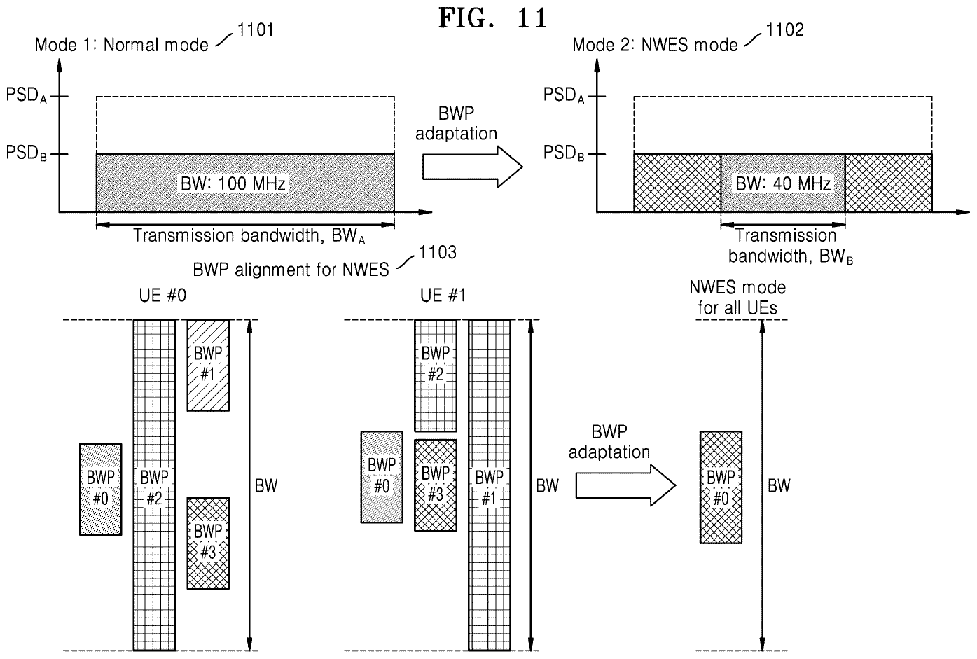

FIG. 11 illustrates a method of reconfiguring a BWP and a BW by dynamic signaling of a wireless communication system, according to an embodiment of the disclosure.

Referring to FIG. 11, the UE may operate on an activated BWP or BW by higher layer signaling or L1 signaling from the BS (1101). For example, the UE may operate on a full BW of 100 MHz with fixed power PSDB. The BS may adjust the BW and BWP so that the UE activates a narrower BW of 40 MHz with same power PSDB for energy saving (1102). At this time, the BS may adjust the BW or BWP for energy saving by L1 signaling. For example, the adjusting of the BW or BWP for energy saving may be performed via group common DCI and cell-specific DCI, and may be configured so that BWP and BW configurations configured to be UE-specific are matched equally (1103). In an example, a UE #0 and a UE #1 may have configurations and positions of different BWPs. In this case, BWs and BWPs of all UEs may be identically set to one for energy saving, by reducing the BW used by the BS. Here, the BWP or BW in an energy saving operation may be configured to be one or more, and may be used to configure a BWP for each UE group. However, this is merely an example, and the L1 signaling for adjusting the BW or BWP for energy saving is not limited to the above example.

In the descriptions of the disclosure, higher layer signaling may be signaling corresponding to at least one of or a combination of signaling methods below.
Master information block (MIB)
System information block (SIB) or SIB X (X=1, 2, . . . )
Radio resource control (RRC)
Medium access control (MAC) control element (CE)

Also, L1 signaling may be signaling corresponding to at least one of or a combination of signaling methods using following physical layer channels or signaling.
Physical downlink control channel (PDCCH)
Downlink control information (DCI)
UE-specific DCI
Group common DCI
Common DCI
Scheduling DCI (e.g., DCI used to schedule DL or UL data)
Non-scheduling DCI (e.g., DCI not for scheduling DL or UL data)
Physical uplink control channel (PUCCH)
Uplink control information (UCI)

Hereinafter, the above examples will be described via a plurality of embodiments of the disclosure, but the embodiments of the disclosure are not independent and one or more embodiments of the disclosure may be applied simultaneously or in combination.

Hereinafter, a discontinuous reception (DRX) alignment method by dynamic signaling for BS energy saving in the 5G system will now be described.

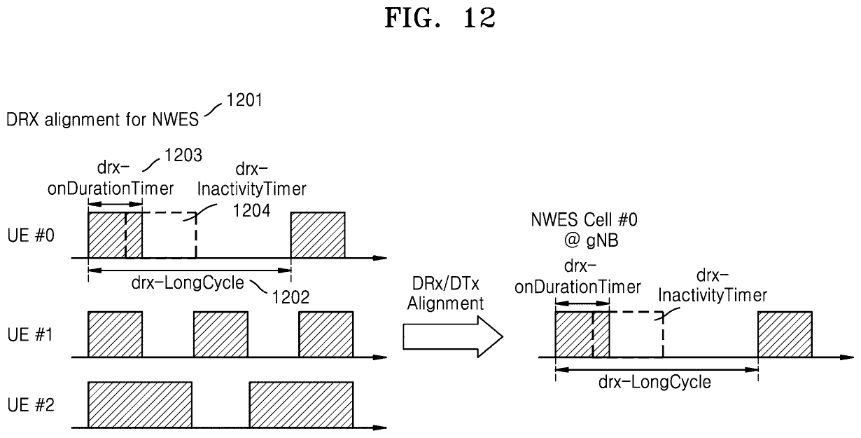

FIG. 12 illustrates a method of reconfiguring DRX by dynamic signaling of a wireless communication system, according to an embodiment of the disclosure.

Referring to FIG. 12, the BS may configure DRX to be UE-specific by higher layer signaling. For example, different drx-LongCycle 1202 or drx-ShortCycle, drx-onDurationTimer 1203, and drx-InactivityTimer 1204 may be configured for the UEs. Afterward, the BS may configure a UE-specific DRX configuration by UE group-specific or cell-specific L1 signaling for energy saving (1201). Accordingly, the BS may achieve, for energy saving, a same effect as the UE saving power through DRX.

A discontinuous transmission (DTx) operation for energy saving of the BS in the 5G system will now be described.

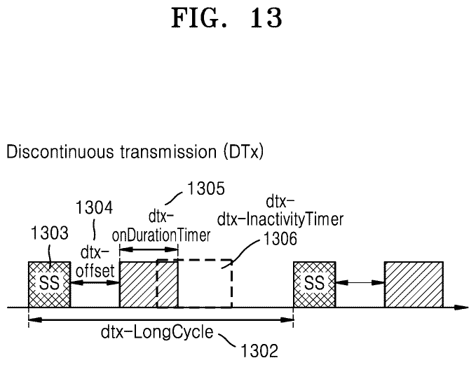

FIG. 13 is a diagram for describing a DTx method for saving energy of the BS, according to an embodiment of the disclosure.

Referring to FIG. 13, the BS may configure DTx for energy saving, by higher layer signaling (new SIB for DTx or RRC signaling) and L1 signaling (DCI). Here, the BS may configure the flowing parameters for a DTx operation: dtx-onDurationTimer 1305 related to transmission of PDCCH for scheduling DL SCH or a reference signal for RRM measurement, beam management, and pathloss measurement, dtx-InactivityTimer 1306 related to reception of PDSCH after receiving the PDCCH for scheduling DL SCH, dtx-offset 1304 of configuring an offset between dtx-onDurationTimer 1305 after transmitting a synchronization signal 1303 for synchronization before dtx-onDurationTimer 1305, and dtx-(Long) Cycle 1302 for DTx to periodically operate based on previous configuration information (configuration information for SS and configuration information for DTx). Also, the BS may configure information for SS (e.g., SSB transmission configuration information and CSI-RS or TRS transmission configuration information) by higher layer signaling and L1 signaling (DCI). Here, dtx-cycle may be configured in plural for a long cycle and a short cycle. During DTx, the BS considers a transmitting end to be in an off (or inactive) state, and accordingly, may not transmit DL control channel (CCH), shared channel (SCH), and DL RS. In other words, the BS may transmit only DL (PDCCH, PDSCH, RS, and the like) for SS, dtx-onDurationTimer, and dtx-InactivityTimer during DTx. SS-gapbetweenBurst or the number of SS bursts may be additionally configured as additional information of the configured SS.

A BS activation method via gNB wake-up signal (WUS) during an inactive mode of the BS for energy saving of the BS in the 5G system will now be described.

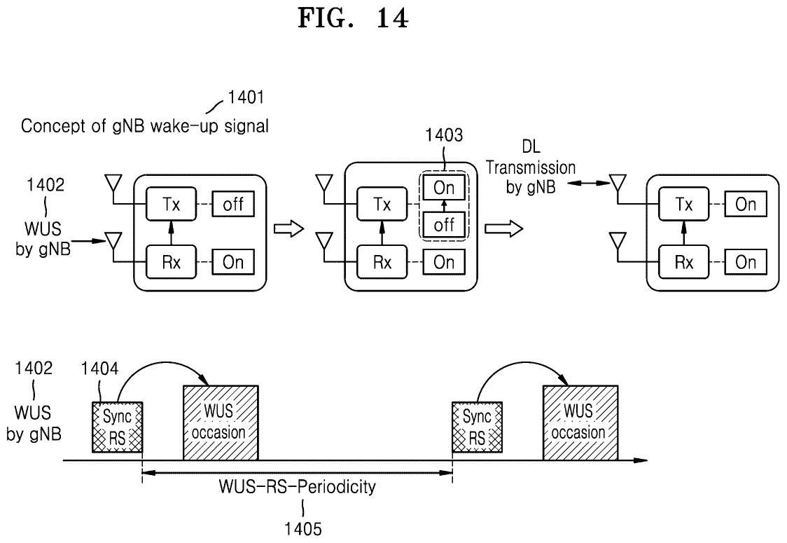

FIG. 14 illustrates an example for describing an operation of the BS according to a gNB wake-up signal, according to an embodiment of the disclosure.

Referring to FIG. 14, a gNB wake-up signal 1401 will now be described. For energy saving, the BS may maintain a transmission end in an off (or inactive) state during an inactive mode (or sleep mode) of the BS. Then, the BS may receive, from the UE, a gNB wake-up signal 1402 for activating the sleep mode of the BS. When a WUS is received through a reception (Rx) end from the UE, the BS may switch a state of the transmission (Tx) end to an on (or active) state (1403). Then, the BS may perform DL transmission to the UE. In this case, the BS may perform synchronization after Tx on and may perform control and data transmission. Also, various UL signals such as a physical random access channel (PRACH), a scheduling request (SR PUCCH), and a PUCCH including acknowledgement may be considered as a gNB WUS. Via the method, the BS may perform energy saving, and at the same time, the UE may improve latency.

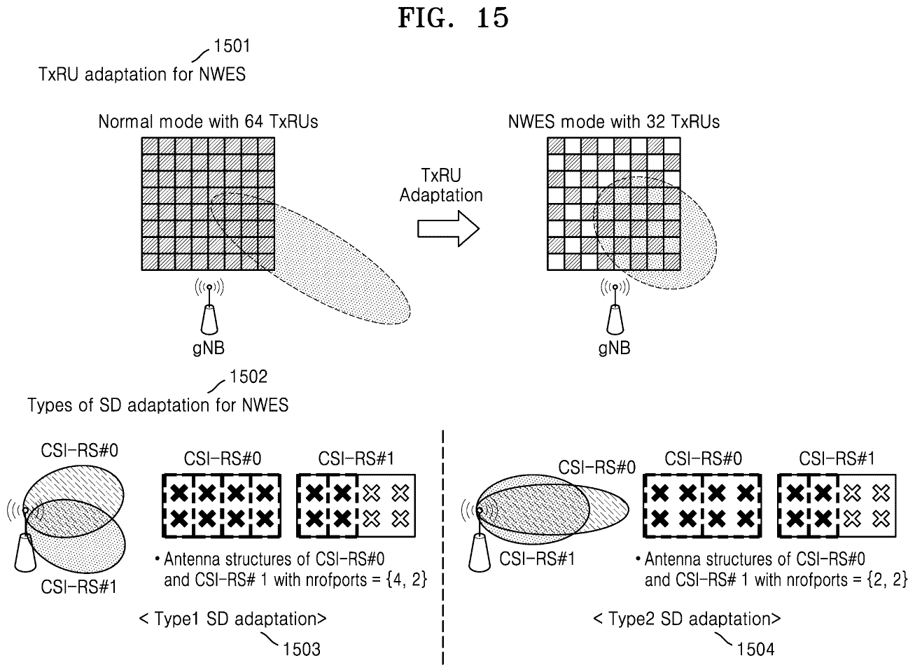

The BS may configure a WUS occasion for receiving a gNB WUS and a sync RS for synchronization before the UE transmits the gNB WUS. Here, SSB, TRS, light SSB (PSS+SSS), consecutive SSBs, or new RS (continuous PSS+SSS) may be considered as the sync RS, and PRACH, PUCCH with SR, or a sequence based signal may be considered as a WUS. A sync RS 1404 for the UE to activate the inactive mode for energy saving of the BS, and the WUS occasion for receiving a WUS may be repeatedly transmitted with WUS-RS periodicity 1405. In FIG. 15, an embodiment of the disclosure is described with an example of 1-to-1 mapping of sync and WUS occasion, but the disclosure is not limited thereto. For example, sync and WUS occasion may be N-to-1 mapped, 1-to-N mapped, or N-to-N mapped.

Hereinafter, a method of dynamically turning on or off a spatial domain element (i.e., an antenna, PA, or transceiver units or transmission radio units (TxRUs)) of the BS for BS energy saving in the 5G system will now be described.

FIG. 15 is a diagram illustrating an antenna adaptation method for the BS for energy saving, in a wireless communication system, according to an embodiment of the disclosure.

Referring to FIG. 15, the BS may adjust a Tx antenna port per radio unit (RU) for network energy savings (NWES) (1501). For example, as a power amplifier (PA) of the BS occupies most energy consumption of the BS, the BS may turn off a Tx antenna so as to save energy. In order to determine whether it is possible to turn off the Tx antenna, the BS may refer/use reference signal received power (RSRP), a channel quality indicator (CQI), and reference signal received quality (RSRQ) of the UE. The BS may perform transmission by adjusting the number of activated Tx antennas per UE group or per UE. Here, the BS may configure the UE with information including at least one of beam information according to antenna on/off or reference signal information (e.g., at least one of a CSI resource, a resource set, or a CSI report), by higher layer signaling (e.g., RRC signaling) or DCI signaling. The BS may reconfigure antenna information according to a change in BWP, by configuring different antenna information for each BWP. Also, the BS may receive CSI feedback from the UE so as to determine whether SD adaptation is available. The BS may determine the SD adaptation (based on the CSI feedback). The BS may receive, from the UE, multi-feedback via antenna structure hypotheses of several antenna patterns for the SD adaptation.

In more detail, the BS may apply a plurality of types (e.g., two types) of SD adaptation for energy saving (1502). For example, the plurality of types may include Type 1 SD adaptation 1503 and Type 2 SD adaptation 1504.

When Type 1 SD adaptation 1503 is applied, the BS may adapt the number of antenna ports while maintaining the number of physical antenna elements per antenna port (i.e., logical port). Here, RF characteristics (e.g., Tx power and beam) per port may be the same. Therefore, the UE may perform measurement by combining CSI-RSs of same ports during CSI measurement (e.g., layer 1-RSRP (L1-RSRP), layer 3-RSRP (L3-RSRP), or the like).

In another method, when Type 2 SD adaptation 1504 is applied, the BS may turn on/off the physical antenna element per port while having the same number of antenna ports (i.e., logical ports). The RF characteristics per port may vary. The UE may perform measurement by distinguishing between the CSI-RSs of the same ports during the CSI measurement. The BS may save energy via one or more of the plurality of types of SD adaptation methods including the above two types of SD adaptation methods.

Hereinafter, an on-demand SSB and SIB1 configuration method for applying an on-demand SSB and SIB for energy saving of the BS in the 5G system will now be described. Also, the term “on-demand” is used to indicate that periodic transmission of a signal is adjusted according to a UL signal of the UE and the determination of the BS, so as to reduce energy consumption of the BS, and may be replaced with other term having a same meaning.

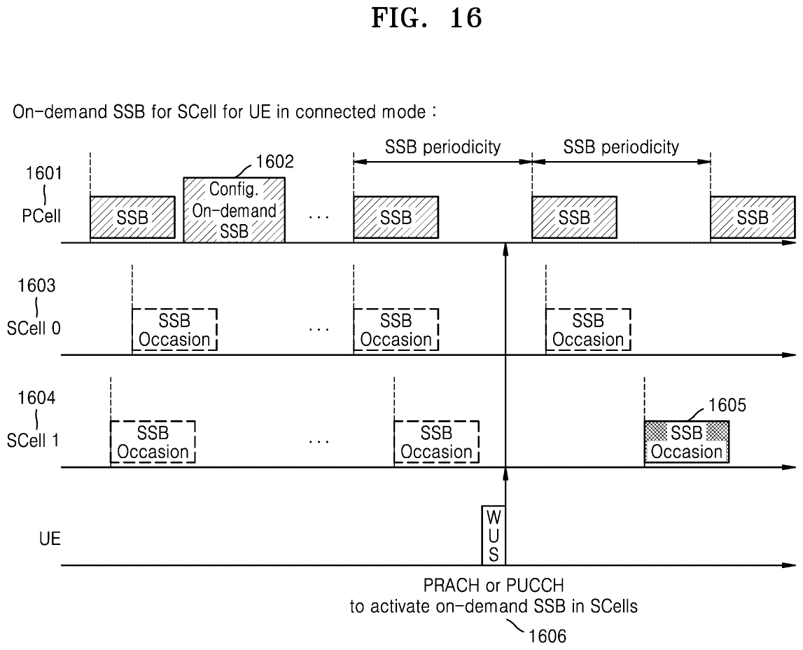

FIG. 16 is a diagram for describing on-demand SSB operations of the BS and the UE, according to an embodiment of the disclosure.

Referring to FIG. 16, the BS may apply the on-demand SSB operation to one SCell or multiple SCells during a CA operation. In more detail, the BS may periodically perform SSB transmission in a PCell 1601. The BS may configure the UE with an on-demand SSB for SCells 1603 and 1604 by at least one of higher layer signaling (e.g., RRC or MAC CE) or L1 signaling or a combination of the signalings. The BS according to an embodiment of the disclosure may provide, to the UE, the on-demand SSB configuration for the SCells 1603 and 1604 by higher layer signaling and L1 signaling. In an example, the BS may configure the UE with the on-demand SSB in the PCell 1601 via RRC signaling 1602. Afterward, based on the configured information, the UE may trigger SSB transmission of SCell #1 1604 via a WUS on an UL channel (e.g., PUCCH or PRACH) 1606. Next, the BS may transmit SSB burst 1605 on the SCell #1 1604 after receiving the WUS. An on-demand SSB configuration and SCell configuration method for the above operations may be configured via one or a combination of the above methods, and SCell activation/deactivation may be determined based on the configuration.

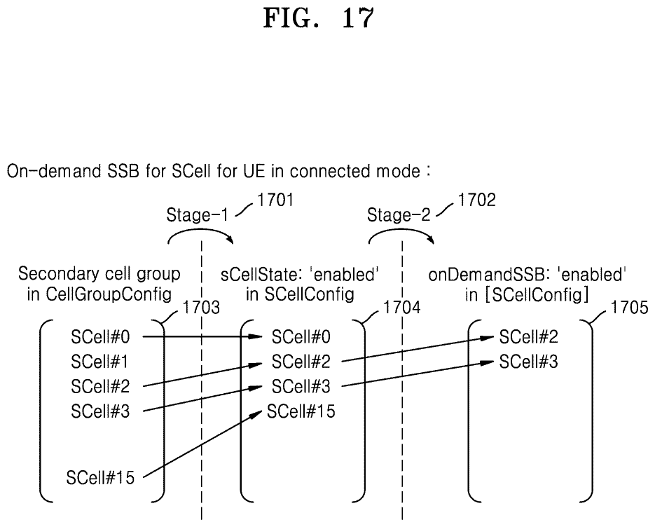

FIG. 17 is a diagram for describing a SCell activation/deactivation and on-demand SSB configuration method by the BS, according to an embodiment of the disclosure.

Referring to FIG. 17, the BS may configure a secondary cell group including candidate Scells by higher layer signaling (e.g., RRC signaling) (1703). Then, the BS may activate or deactivate a SCell by higher layer signaling for each UE (1704). In more detail, the BS may activate or deactivate one or a plurality of SCells by configuring sCellState of RRC signaling SCellconfig as enable or by MAC CE signaling. Then, for the activated SCell, an on-demand operation may be configured via at least one of RRC signaling, MAC CE signaling, or L1 signaling or via a combination of two or more of the signalings (1705). In this regard, the configuration of the on-demand operation may be performed during a process of activating the SCell in stage-1 1701 or may be performed along with SCell activation. The configuration of the on-demand operation may be applied only in stage-2 1702, and in this case, the on-demand operation may be configured via sCell-config for the activated SCell or MAC CE or L1 signaling (e.g., group common DCI, cell common DCI, or UE-specific DCI). Also, the configuration of the on-demand operation may be activated or deactivated simultaneously with the SCell activation.

Via the methods, the BS may configure and indicate the SCell activation/deactivation and the on-demand operation. Then, the UE may determine SSB reception and WUS transmission according to whether the on-demand operation is performed in the SCell, based on the configuration information.

Hereinafter, methods for SCell activation/deactivation and on-demand configuration of the disclosure are proposed. The BS may configure the UE with the on-demand operation including SCell activation/deactivation by using one or a combination of the above methods.

### [Configuration 1]

In Configuration 1 according to an embodiment of the disclosure, the BS may configure configuration information and activation for an on-demand operation in SCell by RRC signaling, for energy saving.

The BS may configure the UE with SCell activation/deactivation and on-demand SSB or SIB1 operation activation/deactivation, by RRC signaling.

For example, the on-demand operation may be configured by sCellConfig of RRC signaling as in Table 13.

TABLE 13

| | |
|---|---|
| sCellConfig ::= | SEQUENCE { |
| sCellIndex | SCellIndex, |
| sCellConfigCommon | ServingCellConfigCommon OPTIONAL, -- Cond SCellAdd |
| sCellConfigDedicated | ServingCellConfig OPTIONAL, -- Cond SCellAddMod |
| ..., | |
| [[ | |

```
  smtc SSB-MTC OPTIONAL -- Need S
]],
[[
sCellState-r16  ENUMERATED {activated} OPTIONAL, -- Cond SCellAddSync
onDemandSSB-r18  ENUMERATED {activated} OPTIONAL
onDemandSIB-r18  ENUMERATED {activated} OPTIONAL
onDemand-r18  ENUMERATED {Disable, SSB, SIB, Both} OPTIONAL
secondaryDRX-GroupConfig-r16  ENUMERATED {true} OPTIONAL -- Need S
]],
[[
  preConfGapStatus-r17 BIT STRING (SIZE (maxNrofGapId-r17)) OPTIONAL, -- Cond
    PreConfigMG
  goodServingCellEvaluationBFD-r17 GoodServingCellEvaluation-r17 OPTIONAL, --
Need R
  sCellSIB20-r17  SetupRelease { SCellSIB20-r17 } OPTIONAL -- Need M
    ]],
  [[
  plmn-IdentityInfoList-r17 SetupRelease {PLMN-Identity InfoList} OPTIONAL, --
  Cond SCellSIB20-Opt
```

| | |
|---|---|
| npn-IdentityInfoList-r17 | SetupRelease {NPN-IdentityInfoList-r16} |

```
    OPTIONAL -- Cond SCellSIB20-Opt
  ]] }
```

The BS may configure the on-demand operation for energy saving of the BS as onDemandSSB-r18, onDemandSIB-r18, or onDemand-r18, by sCellConfig RRC configuration, and thus, may indicate whether to perform the on-demand operation in the SCell corresponding to sCellIndex. However, this is merely an embodiment of the disclosure, and according to another embodiment of the disclosure, information about the on-demand operation may be configured by being included in sCellConfigCommon or sCellConfigDedicated. Configuration information (e.g., periodicity, a pattern, and the number of SSBs) used when the BS or the UE starts transmission by activating on-demand SSB or SIB may be configured by individual RRC signaling. In addition, for SSB, RRC signaling in which a list of specific patterns is organized may be configured, and an SSB pattern for each SCell may be configured based on a pattern index of the list. A multi-pattern configuration method may be applied to the on-demand operation of another channel, such as SIB1. For example, the on-demand operation may be configured together with or independently from the SCell activation/deactivation information. For example, the configuration of the on-demand operation may be applied to SCell of which sCellState is configured as activated. On the other hand, the on-demand operation may be individually configured regardless of SCell activation, and when the BS activates a SCell or when the UE activates an on-demand operation of a deactivated SCell via WUS transmission, a SCell activation operation may also be performed. Also, configuration information of the UE related to WUS transmission for requesting the on-demand operation and WUS pattern information may be configured by RRC signaling.

### [Configuration 2]

In Configuration 2 according to an embodiment of the disclosure, the BS may configure, by MAC CE signaling, whether to activate one SCell or multiple SCells for an on-demand operation in a SCell for energy saving. Also, a pattern for the on-demand operation on the SCell may be indicated.

The BS may configure, by MAC CE, the UE with SCell activation/deactivation and activation/deactivation of an on-demand SSB or SIB1 operation individually or together.

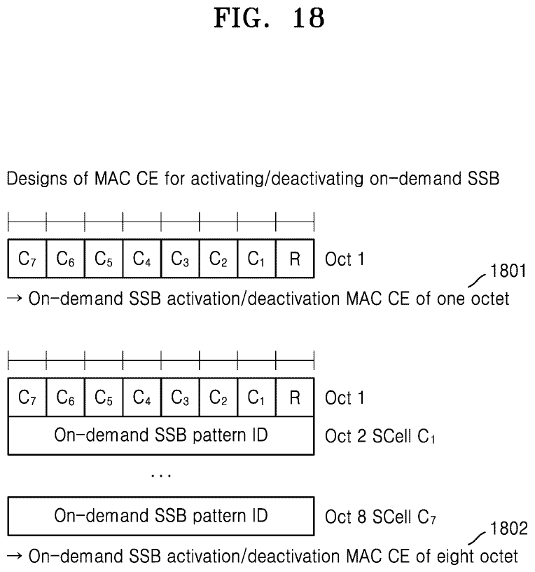

FIG. 18 is a diagram for describing a MAC CE-based SCell activation/deactivation and on-demand SSB configuration method by the BS, according to an embodiment of the disclosure.

Referring to FIG. 18, the BS may indicate on-demand SSB operation activation and on-demand SSB pattern for one SCell or multiple SCells by MAC CE signaling. In detail, the BS may indicate the on-demand SSB operation activation for C₁ to C₇ SCells, via MAC CE having one octet (1801). Also, the BS may indicate the on-demand SSB operation activation for the C₁ to C₇ SCells, via MAC CE having multiple octets, and may indicate the on-demand SSB pattern for each SCell. The BS may select a pattern index from a pattern list configured by RRC signaling and may indicate the on-demand SSB pattern. At this time, the on-demand SSB operation activation and SCell activation/deactivation may also be indicated via the MAC CE. According to an embodiment of the disclosure, a pattern index corresponding to each SCell may be indicated via the MAC CE, based on the pattern list configured by RRC signaling. In detail, via the MAC CE having eight octets, the on-demand SSB operation activation for the C₁ to C₇ SCells may be indicated in one octet and the pattern indices for the C₁ to C₇ SCells may be indicated in 2 to 8 octets (1802).

### [Configuration 3]

In Configuration 3 according to an embodiment of the disclosure, the BS may configure, via DCI, whether to activate one SCell or multiple SCells for an on-demand operation in a SCell for energy saving. Also, an on-demand transmission pattern for the on-demand operation on the SCell may be indicated.

The BS may configure, by the DCI, the UE with SCell activation/deactivation and activation/deactivation of an on-demand SSB or SIB1 operation individually or together. Here, the DCI may be cell-specific DCI, and thus, group common DCI may be applied, or UE-specific DCI may be applied.

For example, a group-common DCI format as in Table 14 may be configured, in consideration of one SCell or multiple SCells.

TABLE 14

| DCI format 2_X is used for notifying on-demand SSB on one | |
|---|---|
| or more the activated SCell by RRC and MAC CE. | |
| The following information is transmitted by means of the | |
| DCI format 2_X with CRC scrambled by Ondemad-RNTI: | |
| - block number 1, block number 2,..., block number N | |
| where the starting position of a block is determined | |
| in order of SCellIndex | |
| The following fields defined for the block: | |
| - | On-demand SSB indication - 1 bit |
| - | On-demand pattern indication - N bit if higher layer |
| | parameter onDemandpatternList is configured |
| - | WUS occasion indication - N bit if higher layer |
| | parameter WUSResourceAllocationList is configured |

The size of DCI format 2_X is determined by the number
of activated SCell.

As shown above, DCI includes multiple blocks for each SCell, and in this case, the number of blocks may be determined according to the number of activated SCells, or candidate SCells belonging to a secondary cell group. The UE may determine the location of the block (i.e., a starting location of a bit) for each SCell, based on information configured by higher layer signaling (e.g., RRC signaling), or may determine the location of the block, based on a SCell index. For example, when the SCell index is configured as {1, 2, 3, 7}, {1, 2, 3, 7} may be allocated to block 1 to block 4, from a small SCell index. Here, each block may include a bit indicating whether to activate the on-demand operation in a corresponding SCell. For example, in consideration of on-demand SSB and SIB, two bits, i.e., “00” may indicate deactivated, “01” may indicate on-demand SSB activation, “10” may indicate on-demand SIB1 activation, and “11” may indicate on-demand SSB and SIB1 activation. Also, after the bit indicating the activation information, a bit indicating WUS configuration information and on-demand pattern information may be included. A configuration of the DCI format may be used in a combination of RRC signaling and MAC CE signaling. For example, when the on-demand operation is applied to a SIB other than an SIB1, a type of the SIB to which the on-demand operation is applied may be configured by using the DCI format by RRC signaling. A configuration of the block described above is merely an example and does not limit the scope of the disclosure. In another example, a bit indicating whether to activate a SCell may be included in each block. According to another embodiment of the disclosure, a plurality of pieces of information that may be included in the block may be included in DCI in the form of a bitmap. For example, a configuration of the on-demand operation for one or more SCells may be provided in the bitmap and the size of the bitmap may be determined by the number of activated SCells or the number of candidate SCells belonging to the secondary cell group.

The BS may configure the UE with the on-demand operation and may activate the on-demand operation, and may also indicate SCell activation/deactivation. Also, values of signalings are merely examples and may be variously configured according to other embodiments of the disclosure.

Energy consumption of the BS may be reduced via the methods and embodiments of the disclosure described above. Also, the methods or embodiments of the disclosure may be simultaneously configured or performed via a combination thereof.

Energy consumption of the BS may be reduced via methods according to an embodiment of the disclosure. The methods according to an embodiment of the disclosure may be configured/used as one or may be simultaneously configured/used via a combination thereof.

According to an embodiment, a method by which the BS can transmit a signal and a channel when necessary, the signal and the channel having been always periodically transmitted, so as to reduce energy consumption is proposed. The BS may determine transmission of a signal that is always periodically transmitted, according to at least one of an UL signal from the UE or determination of the BS. In detail, the BS may transmit a signal such as SSB or SIB1, which is always periodically transmitted, according to the UL signal from the UE and the determination of the BS. In this regard, a method of designing and transmitting the UL signal so as to trigger transmission of on-demand SSB and on-demand SIB1, based on the UL signal from the UE, may be provided. In the disclosure, energy saving, energy consumption reduction, and reduction of energy consumption may be interchangeably used and may be understood to have a same meaning. Unless specifically described otherwise, operations according to the disclosure may be applied to SIB other than SSB and SIB1 in the disclosure.

### First Embodiment

According to the first embodiment of the disclosure, a method of designing a WUS for waking up an on-demand operation for energy saving of a BS and transmitting the WUS in a PCell or a SCell is proposed. In more detail, a UE may determine a design of the WUS, as one or a combination of WUS designs below. Also, the UE may determine a design of the WUS, according to WUS transmission in a PCell or a SCell.

### [Method 1]

According to the Method 1 according to an embodiment of the disclosure, provided is a method, performed by the UE, of transmitting a PUCCH-based WUS to request on-demand transmission while the BS is in an on-demand operation for energy saving.

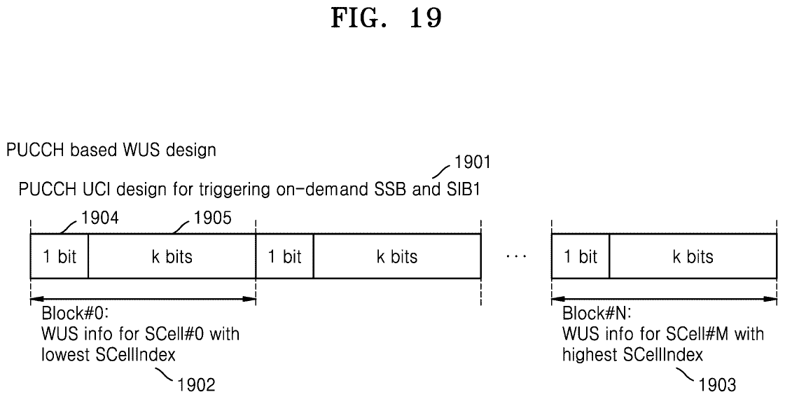

FIG. 19 is a diagram for describing a structure of a WUS for the UE to request an on-demand channel, according to an embodiment of the disclosure.

Referring to FIG. 19, the BS may configure and activate an on-demand SSB operation, based on the aforementioned on-demand configuration and activation method, with respect to one SCell or multiple SCells during a CA operation. Afterward, based on the configured information, a structure of a WUS having multiple blocks for requesting on-demand SSB or SIB1 in the one SCell or the multiple SCells may be determined (1901). In more detail, a payload size of the WUS for the on-demand SSB or SIB1 may be determined as a sum of information bits of all blocks, and each block corresponds to one SCell. Each block may be configured of 1 bit for requesting the on-demand SSB or SIB1 and k bits indicating a pattern of on-demand transmission. For example, block #0 1902 for SCell #0 may be configured of 1 bit 1904 for requesting on-demand SSB or SIB1 and k bits 1905 indicating a pattern of on-demand transmission.

The number of bits 1904 of each block so as to request on-demand SSB or SIB1 may be determined according to the number of on-demand channels supported by a SCell corresponding thereto. For example, if SCell #0 supports only on-demand SSB, SSB may be requested via 1 bit, and if SCell #1 supports on-demand SSB and SIB1, SSB and SIB1 may be respectively requested via 2 bits. On the other hand, in order to minimize a payload size of UCI, a corresponding block may be always fixed to 1 bit to simultaneously request on-demand SSB and SIB1 according to configuration of SCell. According to another example, in order to minimize a payload size of UCI, an on-demand operation may be configured for not only SIB1 but also for another SIB (e.g., SIB X) via RRC or MAC CE configuration, and the UE may request on-demand SIB X by transmitting the UCI with a fixed number of bits, based on the configuration.

The number of k bits 1905 of each block so as to request a pattern of on-demand SSB or SIB1 may be determined according to a size of a pattern list configured by higher layer signaling, and if a pattern list is configured for each of on-demand SSB and on-demand SIB, corresponding k bits may be determined as a sum of kssB determined by the pattern list of the on-demand SSB and ksIB1 determined by the pattern list of the on-demand SIB1. Respective sizes of blocks may be equally or differently configured according to on-demand configuration for SCell.

In this regard, the number of WUS blocks may be determined according to the number of activated SCells or the number of SCells supporting an on-demand operation from among the activated SCells. According to another method, the number of WUS blocks may be determined according to the number of SCells of a secondary cell group configured by higher layer signaling. Afterward, for a PUCCH configured of multiple blocks, a UCI bit allocation order may be determined according to a mapping order based on SCell indices. For example, block #1 having a lowest SCell index may be mapped to a first UCI bit, and then block #N 1903 having a highest SCell index according to an order of the SCell indices may be mapped to a last UCI bit. According to another method, a mapping order may be determined according to SCell priority order configuration from the BS, and a dropping rule between blocks may also be considered. The method is merely an embodiment of one WUS structure, and the WUS structure does not limit the scope of a WUS proposed in the disclosure. According to yet another method, UCI of a PUCCH may be used to request on-demand channel transmission of one SCell or multiple SCells by using a SCell indicator SCI indicating an index of a SCell for which the UE requests an on-demand operation. Also, in a case of a PUCCH for the WUS, the PUCCH may be transmitted in a PCell or a configured WUS occasion of each SCell. In this regard, when the UE transmits the WUS on the PUCCH in the PCell, reliability of PUCCH transmission may be ensured, and on-demand transmission of one SCell or multiple SCells may be requested, which are efficient. On the other hand, when the UE transmits the WUS on the PUCCH in a SCell, on-demand transmission may be requested only in the corresponding SCell, and thus, a payload size of the PUCCH may be decreased.

### [Method 2]

According to the Method 1 according to an embodiment of the disclosure, provided is a method, performed by the UE, of transmitting a PRACH-based WUS to request on-demand transmission while the BS is in an on-demand operation for energy saving.

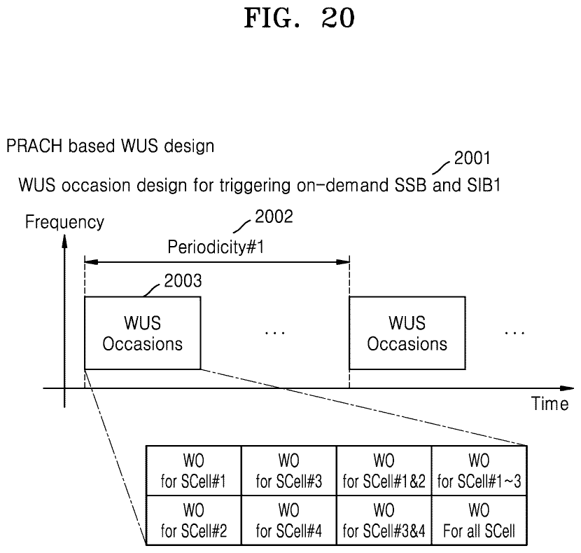

FIG. 20 is a diagram for describing a structure of a WUS occasion for the UE to request an on-demand channel, according to an embodiment of the disclosure.

Referring to FIG. 20, the BS may configure and activate an on-demand SSB operation, based on the aforementioned on-demand configuration and activation method, with respect to one SCell or multiple SCells during a CA operation. Afterward, based on the configured information, a PRACH for requesting on-demand SSB or SIB1 in the one SCell or the multiple SCells may be transmitted (2001). Here, a WUS occasion for PRACH-based WUS transmission may be configured with periodicity #1 2002. The WUS occasion may be configured of one or more frequency divisional multiplexed (FDMed) or time divisional multiplexed (TDMed) WUS occasions, and each WUS occasion may be mapped to the one SCell or the multiple SCells. Afterward, when PRACH transmission is performed on a corresponding WUS occasion resource, the BS may determine that on-demand transmission has been requested in a SCell mapped to the corresponding WUS occasion. In an example, WUS occasions 2003 may have eight FDMed & TDMed WUS occasions, and each WUS occasion may be mapped to the one SCell or the multiple SCells.

Also, in order to distinguish the PRACH from a PRACH used in an existing RACH procedure, the BS may configure a separate PRACH preamble format or may set a WUS occasion separately from a RACH occasion. According to another method, the BS may determine and indicate a PRACH root sequence index as an index for new on-demand SSB or SIB1.

According to the methods above, the UE may request on-demand channel transmission of the BS, by using a PUCCH or a PRACH. The scope of an embodiment of the disclosure is not limited to the embodiment, and on-demand channel transmission in one SCell or multiple SCells may be requested via the PUSCH having the MAC CE structure. The UE may also request the BS for SCell activation/deactivation. By doing so, the BS may save energy by transmitting a channel and a signal in an on-demand manner, the channel and the signal being requested for always periodic transmission.

### Second Embodiment

According to the second embodiment of the disclosure, a method, performed by a UE, of transmitting a WUS while a BS is in an on-demand operation for energy saving may be provided. Hereinafter, flowcharts and block diagrams of the UE and the BS with respect to an on-demand request using a WUS will now be described.

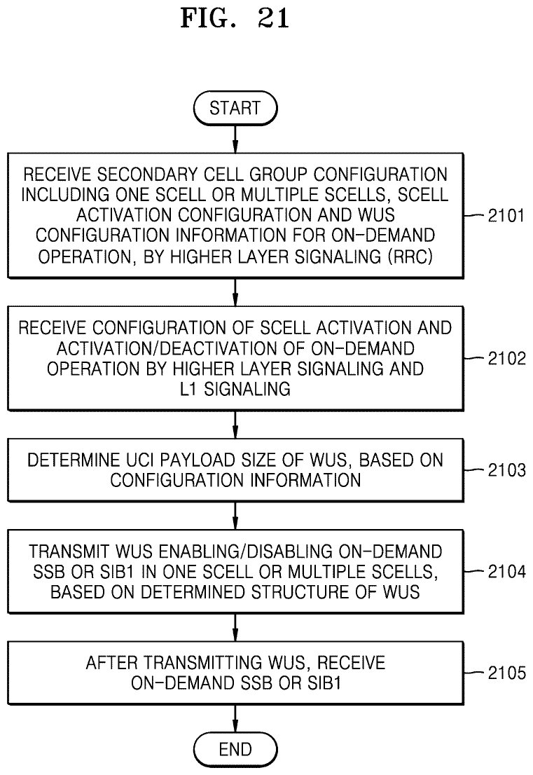

FIG. 21 is a flowchart of an energy saving method performed by the UE in a wireless communication system, according to an embodiment of the disclosure.

In operation 2101, the UE may receive secondary cell group configuration information including one SCell or multiple SCells, SCell activation configuration information, and WUS configuration information for an on-demand operation for energy saving, from the BS by higher layer signaling (RRC).

In operation 2102, the UE may receive configuration of SCell activation and activation/deactivation of the on-demand operation by higher layer signaling and L1 signaling.

In operation 2103, the UE may determine a UCI payload size of a WUS, based on the configuration information.

In operation 2104, the UE may transmit the WUS enabling/disabling an on-demand SSB or SIB1 in the one SCell or the multiple SCells, based on the determined structure of the WUS.

In operation 2105, after transmitting the WUS, the UE may receive the on-demand SSB or SIB1.

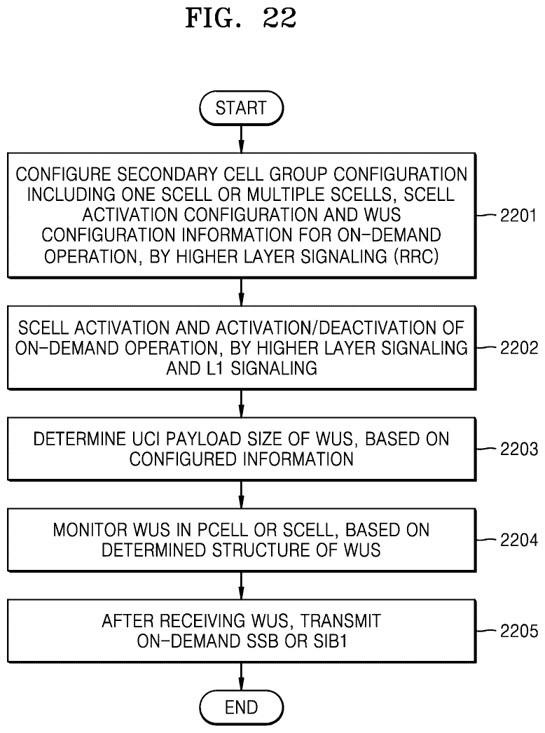

FIG. 22 is a flowchart of an energy saving method performed by the BS in a wireless communication system, according to an embodiment of the disclosure.

In operation 2201, the BS may configure, by higher layer signaling (RRC), the UE with secondary cell group configuration information including one SCell or multiple SCells, SCell activation configuration information, and WUS information for an on-demand operation for energy saving of the BS.

In operation 2202, the BS may indicate the UE with SCell activation and activation/deactivation of the on-demand operation, by higher layer signaling and L1 signaling.

In operation 2203, the BS may determine a UCI payload size of a WUS, based on the configured information.

In operation 2204, the BS may monitor the WUS in a PCell or a Scell, based on the determined structure of the WUS.

In operation 2205, after receiving the WUS, the BS may transmit the on-demand SSB or SIB1.

The flowcharts described above illustrate methods that may be implemented according to the principles of the disclosure, and various modifications may be made to the methods illustrated in the flowcharts of the disclosure. For example, although illustrated as a series of operations, the various operations in each drawing may overlap, occur in parallel, occur in different orders, or occur multiple times. In another example, an operation may be omitted or replaced with another operation.

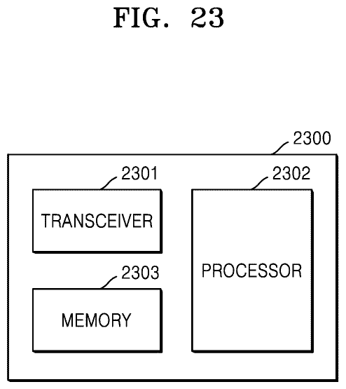

FIG. 23 is a block diagram of a UE, according to an embodiment of the disclosure.

Referring to FIG. 23, a UE 2300 may include a transceiver 2301, a controller (e.g., a processor) 2302, and a storage (e.g., memory) 2303. The transceiver 2301, the controller 2302, and the storage 2303 of the UE 2300 may operate according to at least one or a combination of the methods according to the embodiments of the disclosure described above. However, elements of the UE 2300 are not limited thereto. According to another embodiment, the UE 2300 may include more elements than the shown elements or may include fewer elements than the shown elements. In addition, in a specific case, the transceiver 2301, the controller 2302, and the storage 2303 may be implemented as one chip.

According to an embodiment, the transceiver 2301 may include a transmitter and a receiver. The transceiver 2301 may transmit and receive signals to and from a BS. The signals may include control information and data. The transceiver 2301 may include a radio frequency (RF) transmitter for up-converting and amplifying a frequency of signals to be transmitted, and an RF receiver for low-noise-amplifying and down-converting a frequency of received signals. The transceiver 2301 may receive signals via wireless channels and output the signals to the controller 2302, and may transmit signals output from the controller 2302, via wireless channels.

The controller 2302 may control a series of procedures to allow the UE 2300 to operate according to the embodiment of the disclosure. For example, the controller 2302 may perform or control operations of the UE 2300 for performing at least one or a combination of the methods according to the embodiments of the disclosure. The controller 2302 may include at least one processor. For example, the controller 2302 may include a communication processor (CP) for performing control for communication, and an application processor (AP) for controlling a higher layer (e.g., an application), etc.

The storage 2303 may store control information (information related to channel estimation using DMRSs transmitted on a PUSCH, which is included in a signal obtained by the UE 2300) or data, and may have areas for storing data necessary for control by the controller 2302 and data occurring in the control by the controller 2302).

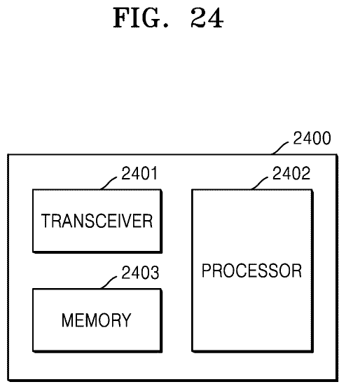

FIG. 24 is a block diagram of a BS, according to an embodiment of the disclosure.

Referring to FIG. 24, a BS 2400 may include a transceiver 2401, a controller (e.g., a processor) 2402, and a storage (e.g., memory) 2403. The transceiver 2401, the controller 2402, and the storage 2403 of the BS 2400 may operate according to at least one or a combination of the methods according to the embodiments of the disclosure described above. However, elements of the BS 2400 are not limited thereto. According to another embodiment, the BS 2400 may include more elements than the shown elements or may include fewer elements than the shown elements. In addition, in a specific case, the transceiver 2401, the controller 2402, and the storage 2403 may be implemented as one chip.

According to an embodiment of the disclosure, the transceiver 2401 may include a transmitter and a receiver. The transceiver 2401 may transmit and receive signals to and from a UE. The signals may include control information and data. The transceiver 2401 may include a RF transmitter for up-converting and amplifying a frequency of signals to be transmitted, and an RF receiver for low-noise-amplifying and down-converting a frequency of received signals. The transceiver 2401 may receive signals via wireless channels and output the signals to the controller 2402, and may transmit signals output from the controller 2402, via wireless channels.

The controller 2402 may control a series of procedures to allow the BS 2400 to operate according to the embodiment of the disclosure. In an example, the controller 2402 may perform or control operations of the BS 2400 for performing at least one or a combination of the methods according to the embodiments of the disclosure. The controller 2402 may include at least one processor. For example, the controller 2402 may include a CP for performing control for communication, and an AP for controlling a higher layer (e.g., an application), etc.

The storage 2403 may store control information (information generated related to channel estimation using DMRSs transmitted on a PUSCH, which are determined by the BS 2400), data, control information or data which is received from the UE, or data, and may have areas for storing data necessary for control by the controller 2402 and data occurring in the control by the controller 2402.

Although the drawings illustrate different examples of UEs/BSs, various changes may be made to the drawings. For example, a UE/base station may include any number of elements in any appropriate arrangement. In general, the drawings do not limit the scope of the disclosure to any particular setting. Furthermore, while the drawings illustrate an operating environment in which various features of the UE/BS described in the patent document may be used, the features may be used in any other appropriate system.

The disclosure has been described with reference to embodiments of the disclosure, various changes and modifications may be presented to one of ordinary skill in the art. It is intended that the disclosure covers the changes and modifications within the scope of the appended claims. The description in the disclosure should not be construed as implying that any specific element, operation, or function is essential to the scope of the claim. The scope of the patented subject matter is defined by the claims.

According to an embodiment, via an on-demand operation of a BS in a 5G mobile communication system, a signal and a channel (e.g., SSB or SIB1) which have been always periodically transmitted are transmitted only when necessary, and thus, unnecessary energy consumption of the BS may be reduced. To this end, a method of designing and transmitting a WUS for a UE to request the BS for on-demand transmission may be provided.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, on a cell of a base station, configuration information regarding an uplink (UL) wake up signal (WUS) for at least one cell;
transmitting, via physical random access channel (PRACH), the UL WUS based on the configuration information; and
receiving an on-demand system information block (SIB) on the at least one cell, based on the UL WUS.

2. The method of claim 1, wherein the configuration information includes information regarding PRACH preamble for the UL WUS.

3. The method of claim 1,
wherein the UL WUS includes at least one block corresponding to the at least one cell, and
wherein each of the at least one block includes n bit for requesting the SIB on the at least one cell and k bit for indicating transmission pattern of the on-demand SIB.

4. The method of claim 1, wherein the configuration information is received via radio resource control (RRC) or medium access control (MAC) control element (CE).

5. The method of claim 1, wherein the UL WUS is transmitted on WUS occasion corresponding to the at least one cell.

6. A method performed by a base station in a wireless communication system, the method comprising:
transmitting, on a cell of the base station, configuration information regarding an uplink (UL) wake up signal (WUS) for at least one cell, to a user equipment;
receiving, via physical random access channel (PRACH), the UL WUS based on the configuration information; and
transmitting an on-demand system information block (SIB) on the at least one cell, based on the UL WUS.

7. The method of claim 6, wherein the configuration information includes information regarding PRACH preamble for the UL WUS.

8. The method of claim 6,
wherein the UL WUS includes at least one block corresponding to the at least one cell, and
wherein each of the at least one block includes n bit for requesting the SIB on the at least one cell and k bit for indicating transmission pattern of the on-demand SIB.

9. The method of claim 6, wherein the configuration information is transmitted via radio resource control (RRC) or medium access control (MAC) control element (CE).

10. The method of claim 6, wherein the UL WUS is received on WUS occasion corresponding to the at least one cell.

11. A user equipment (UE) in a wireless communication system, the UE comprising:
a transceiver; and
at least one processor coupled with the transceiver and configured to:
receive, on a cell of a base station, configuration information regarding an uplink (UL) wake up signal (WUS) for at least one cell,
transmit, via physical random access channel (PRACH), the UL WUS based on the configuration information, and
receive an on-demand system information block (SIB) on the at least one cell, based on the UL WUS.

12. The UE of claim 11, wherein the configuration information includes information regarding PRACH preamble for the UL WUS.

13. The UE of claim 11,
wherein the UL WUS includes at least one block corresponding to the at least one cell, and
wherein each of the at least one block includes n bit for requesting the SIB on the at least one cell and k bit for indicating transmission pattern of the on-demand SIB.

14. The UE of claim 11, wherein the configuration information is received via radio resource control (RRC) or medium access control (MAC) control element (CE).

15. The UE of claim 11, wherein the UL WUS is transmitted on WUS occasion corresponding to the at least one cell.

16. A base station in a wireless communication system, the base station comprising:
a transceiver; and
at least one processor coupled with the transceiver and configured to:
transmit, on a cell of the base station, configuration information regarding an uplink (UL) wake up signal (WUS) for at least one cell, to a user equipment,
receive, via physical random access channel (PRACH), the UL WUS based on the configuration information, and
transmit an on-demand system information block (SIB) on the at least one cell, based on the UL WUS.

17. The base station of claim 16, wherein the configuration information includes information regarding PRACH preamble for the UL WUS.

18. The base station of claim 16,
wherein the UL WUS includes at least one block corresponding to the at least one cell, and
wherein each of the at least one block includes n bit for requesting the SIB on the at least one cell and k bit for indicating transmission pattern of the on-demand SIB.

19. The base station of claim 16, wherein the configuration information is transmitted via radio resource control (RRC) or medium access control (MAC) control element (CE).

20. The base station of claim 16, wherein the UL WUS is received on WUS occasion corresponding to the at least one cell.
